(19) United States
(12) Patent Application Publication
(10) Pub. No.: US 2026/0162446 A1
(43) Pub. Date: Jun. 11, 2026

(54) DEPTH-ENHANCED HUMAN POSE AND SIZE ESTIMATION USING OCCLUSION-AWARE NEURAL NETWORKS

(71) Applicant: Nvidia Corporation, Santa Clara, CA (US)

(72) Inventors: Sakthivel Sivaraman, San Jose, CA (US); Rajath Shetty, Sunnyvale, CA (US)

(21) Appl. No.: 18/975,982

(22) Filed: Dec. 10, 2024

(51) Int. Cl. G06V 20/59; G06T 7/215; G06T 7/246; G06T 7/50; G06V 10/25; G06V 10/26; G06V 10/82; G06V 20/70

(52) U.S. Cl. CPC G06V 20/597; G06T 7/215; G06T 7/251; G06T 7/50; G06V 10/25; G06V 10/273; G06V 10/82; G06V 20/70; G06T 2207/20081; G06T 2207/20084; G06T 2207/30268

(57) ABSTRACT

Methods and systems are disclosed for estimating 3D poses and sizes of vehicle occupants using neural networks. An image of the vehicle's interior is captured and a monocular depth map is generated. Both the depth map and the image are fed into a 3D pose estimation network as a combined four-channel RGBD input. The neural network may include an occlusion-aware masking layer that generates occlusion scores for key points associated with the occupant. The occlusion scores help the network adjust the weighting of depth information, such that key points with higher occlusion scores, indicating a greater likelihood of being hidden or partially obscured, receive lower weight. Scaling functions that estimate scale factors integrate depth information with the occlusion-aware masks to estimate the absolute depth positions of key points.

### BACKGROUND

Modern automobiles are often equipped with safety and comfort systems designed to ensure the well-being of vehicle occupants. Traditional in-cabin safety mechanisms, such as airbags and seatbelts, are designed to protect occupants during collisions or sudden stops. However, their effectiveness can be compromised if the position and size of the occupants are not accurately known. This lack of information can lead to safety mechanisms being either overly aggressive or insufficiently deployed, which may potentially result in injuries that could have been prevented with more accurate occupant data. Furthermore, accurately determining the 3D pose and size of vehicle occupants is beneficial for applications such as posture classification, activity recognition, and human-machine interface (HMI) interactions. For example, tracking a driver's eye gaze, head pose, or blinking patterns can detect drowsiness, fatigue, and distraction. The determined 3D pose and size estimation can also be used in applications such as hand position and gesture detection, integration with seat belt reminders, seat heating, and smart airbag deployment. Additionally, occupant monitoring can help prevent potentially dangerous situations, such as ensuring that children or pets are not unintentionally left alone in the vehicle. As such, accurately determining the 3D pose and size of occupants in real-world dimensions may significantly enhance these safety and comfort systems.

### BRIEF DESCRIPTION OF THE DRAWINGS

Various embodiments in accordance with the present disclosure will be described with reference to the drawings, in which:

FIG. 1 illustrates an example data flow diagram for a system for depth-guided 3D human pose estimation and occupant height/size estimation in vehicles, according to at least one embodiment;

FIG. 2 illustrates one embodiment of a depth-enhanced 3D pose estimation module, according to at least one embodiment;

FIG. 3A illustrates one embodiment of an occlusion-aware masking module, according to at least one embodiment;

FIGS. 3B-3C show two example scenarios where key points and associated occlusion scores are illustrated for an occupant within a vehicle, according to at least one embodiment;

FIG. 4 illustrates an example scale factor estimation module, according to at least one embodiment;

FIG. 5 illustrates an example training process of a neural network pipeline used for depth-guided 3D pose estimation and height prediction of vehicle occupants, according to at least one embodiment;

FIG. 6 illustrates an example process flow diagram for estimating the three-dimensional (3D) pose and size of a vehicle occupant using a depth-enhanced size estimation system, according to at least one embodiment;

FIG. 7 illustrates an example networked system 700 that includes a depth-enhanced pose and size estimation system, in accordance with various embodiments;

FIG. 8A illustrates inference and/or training logic, according to at least one embodiment;

FIG. 8B illustrates inference and/or training logic, according to at least one embodiment;

FIG. 9 illustrates an example data center system, according to at least one embodiment;

FIG. 10 illustrates a computer system, according to at least one embodiment;

FIG. 11 illustrates a computer system, according to at least one embodiment;

FIG. 12 illustrates at least portions of a graphics processor, according to one or more embodiments;

FIG. 13 illustrates at least portions of a graphics processor, according to one or more embodiments;

FIG. 14 is an example data flow diagram for an advanced computing pipeline, in accordance with at least one embodiment;

FIG. 15 is a system diagram for an example system for training, adapting, instantiating and deploying machine learning models in an advanced computing pipeline, in accordance with at least one embodiment; and

FIGS. 16A and 16B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice-such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Approaches in accordance with various embodiments of the disclosure are directed towards systems and methods for estimating the three-dimensional (3D) pose and size of vehicle occupants using neural networks. Unlike previous methods that process depth data and estimate 3D pose separately, embodiments in accordance with an end-to-end approach are disclosed for 3D pose determination and size estimation. Depth information may be simultaneously interpreted during 3D pose estimation for a more comprehensive understanding of how the depth information and 3D pose estimation interact with each other. An example process in accordance with one embodiment may begin with capturing an image of the vehicle's interior and generating a monocular depth map from this image. Both the depth map and the image may then be cropped to focus on the region of interest (ROI) which may correspond to an occupant within the vehicle. This cropped image and depth map are fed into a 3D pose estimation network as a combined four-channel Red, Green, Blue and Depth (RGBD) input. The neural network may include an occlusion-aware masking layer that generates occlusion scores for one or more key points (e.g., joints) associated with the vehicle occupant. The occlusion scores may help the network adjust the weighting of depth information, such that key points with higher occlusion scores, indicating a greater likelihood of being hidden or partially obscured, receive lower weight. These masks can be learned in a supervised manner or through weak supervision using relative depth between joints if labeled data is insufficient. Additionally, scaling functions that estimate scale factors may integrate depth information with the occlusion-aware masks to estimate the absolute depth positions of key points. Scale factors are derived to convert relative 3D pose estimates into absolute 3D poses that correspond to real-world dimensions. As used herein, real-world dimensions may refer to the actual, physical measurements in the real world, typically expressed in standard units such as meters, feet, or inches. The scale factor estimation loss is determined by calculating the mean squared error (MSE) between the scaled joint positions and their ground truth absolute positions when available. In cases where ground truth absolute positions are unavailable, the height estimation loss and/or limb estimation loss may indirectly guide the scale factor estimation. This loss is then integrated into the overall loss function to optimize the neural network during training. The resultant absolute 3D occupant pose and size information may then be utilized in various applications of the vehicle's comfort and safety systems.

Approaches in accordance with at least one embodiment may provide several technical advantages and improvements over traditional methods of estimating 3D pose and size of vehicle occupants. Traditional methods may rely on separate processes for interpreting depth data and performing pose estimation. For example, prior implementations may include one process that estimates depth from an image and another process that estimates 3D poses based on optical sensor image. In contrast, disclosed systems and methods may employ an end-to-end approach that integrates depth information with pose estimation into a unified process, which allows it to simultaneously interpret pose and depth information. By learning to understand how these two types of data interact, a depth-guided pose estimation system achieves more accurate localization of body joints and better modeling of limb orientations. Such simultaneous interpretation ensures a complete understanding of spatial context of the occupants and may lead to a more accurate and reliable 3D pose estimation.

Additionally, the inclusion of an occlusion-aware masking layer in occupant pose and size estimation increases robustness when handling occlusions, which is commonly seen on vehicle occupants. In vehicle interiors, occupants often occlude each other or are obscured by objects like seats, or they may self-occlude due to occupant body positioning. Traditional methods may struggle with these occlusions, which often lead to inaccurate pose estimations. The occlusion-aware masking layer in disclosed systems and methods address this challenge by integrating occlusion information into the estimation process. The occlusion-aware masking layer may generate occlusion scores for each joint. The occlusion scores may allow the network to adjust the weighting of depth information based on the likelihood of occlusion. For example, if a joint is likely to be hidden or partially visible, it receives a lower weight(ing) and the prediction may rely more on the visible and accurately detected joints. Such adaptive weighting may ensure accurate pose detection even when certain body parts are hidden or partially obscured. By dynamically adjusting to the presence of occlusions, such a depth-guided estimation system may provide more reliable and precise 3D pose and size estimations.

Moreover, such a depth-guided pose and size estimation pipeline may reduce error propagation compared to traditional implementations. In prior methods, because depth and pose are processed independently and then naively combined, errors from each stage can be combined and amplified, which may lead to greater inaccuracies in the final output. In contrast, the disclosed systems and methods jointly optimize both depth and pose estimation tasks within a single, integrated framework. By handling depth and pose estimation comprehensively, each stage can inform and correct the other during the training process, which leads to a more coherent and accurate final result. Such a cohesive optimization allows dynamic adjustment and refinement of estimation based on combined depth and pose data, which may minimize the risk of compounding errors. By reducing error propagation and improving the precision of 3D pose and size estimations, the depth-guided system ensures more reliable and efficient operation of these critical safety and comfort systems, ultimately contributing to a safer and more comfortable driving experience.

Variations of this and other such functionality can be used as well within the scope of the various embodiments as would be apparent to one of ordinary skill in the art in light of the teachings and suggestions contained herein.

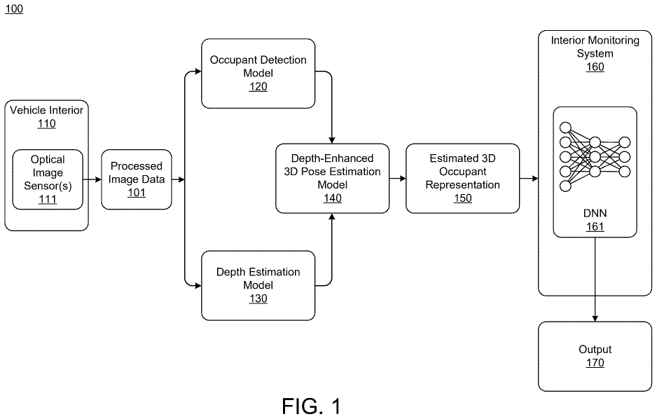

FIG. 1 illustrates an example data flow diagram 100 for a system for depth-guided 3D human pose estimation and occupant height/size estimation in vehicles, in accordance with embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As illustrated in FIG. 1, one or more optical image sensors 111 may be positioned within the vehicle interior 110 to capture high-resolution Red, Green, Blue (RGB) images. An optical image sensor 111 may comprise, for example, a camera or other optical sensor that captures RGB, infrared (IR), and/or RGB-IR image frames. In some embodiments, the optical image sensor 111 may comprise an Occupant Monitoring System (OMS) sensor. This sensor can be designed to operate under various lighting conditions within the vehicle. The captured images may be pre-processed to enhance features relevant for occupant detection, including normalization, noise reduction, and/or Region of Interest (ROI) extraction, which focus on areas where occupants are likely to be located.

The pre-processed images 101 may then be fed into an occupant detection model 120 and a depth estimation model 130. The occupant detection model 120 may use machine learning algorithms such as convolutional neural networks (CNNs) to identify key features such as faces, body parts, and outlines of occupants, and generate bounding boxes and confidence scores for detected occupants. The depth estimation model 130 may process the image data 101 to generate depth maps. Utilizing monocular depth estimation models, the depth estimation model 130 may predict depth information from images by learning spatial relationships and patterns and produce pixel-wise depth information for accurate 3D pose estimation.

The outputs from the occupant detection model 120 and depth estimation models 130 are combined and processed by a depth-enhanced 3D pose estimation model 140. Such a model may integrate a four-channel input, that is Red, Green, Blue and Depth (RGBD), to estimate the 3D pose and size of vehicle occupants. Such a depth-enhanced 3D pose estimation model 140 may integrate an occlusion-aware masking layer that adjusts the weighting of depth information for occluded joints to ensure robust pose estimations even in complex vehicle interior environments.

The estimated 3D poses are used to form an estimated 3D representation 150 of the occupant. Outputs from the depth-enhanced 3D pose estimation model 140 are used to determine an absolute (e.g., true-scale) 3D pose and generate a 3D representation of the occupant that is output as 3D occupant representation data 150. The 3D occupant representation data 150 may include at least one characteristic representative of a size of the occupant (e.g., the occupant's height and/or body limb lengths). Characteristics included in the 3D occupant representation data 150 may comprise a representation such as a 3D pose estimate, a 3D size estimate, and/or a 3D shape estimate of the vehicle occupant.

Based at least in part on the 3D occupant representation data 150, an interior monitoring system 160 may generate one or more output(s) 170. Output(s) 170 may be generated using one or more machine learning models and/or deep neural networks (DNNs) 161. For example, the DNNs may process the 3D data to identify abnormal postures, potential safety risks, and other critical conditions. As an example, the interior monitoring system 160 may use 3D occupant representation data 150 (either alone or in combination with other data such as optical image data 107) to predict the presence and/or location of occupants-such as objects, persons, and/or animals-within the interior space of the vehicle 800. Other systems of the vehicle may determine one or more actions to take based on the predictions and/or may control other tasks or operations. For example, based on output(s) 170, an alarm or warning may be generated, door locks and/or windows may be operated, various functions may be turned on/off, data for a digital assistant, chat bot, digital avatar, and/or the like may be generated, and/or air conditioning or air circulation functions may be operated. In some embodiments, the characteristic representing the size of the occupant from the 3D occupant representation data 150 may be used in conjunction with a child presence detection system to estimate an age of the occupant, and/or control an alert system (e.g., alarm and/or notification systems) based on determining that an occupant under an estimated age threshold may have been inadvertently left alone in the vehicle. In some embodiments, the characteristic representing the size of the occupant may be used in conjunction with other vehicle safety features. For example, in some embodiments, airbag deployments, driver monitoring systems, HMI applications, and/or other vehicle functions may be controlled based at least on a 3D pose, 3D shape, and/or 3D size estimate of the vehicle occupant provided by the 3D occupant representation data 150. Functionalities associated with a depth-enhance 3D pose estimation process is discussed in greater detail.

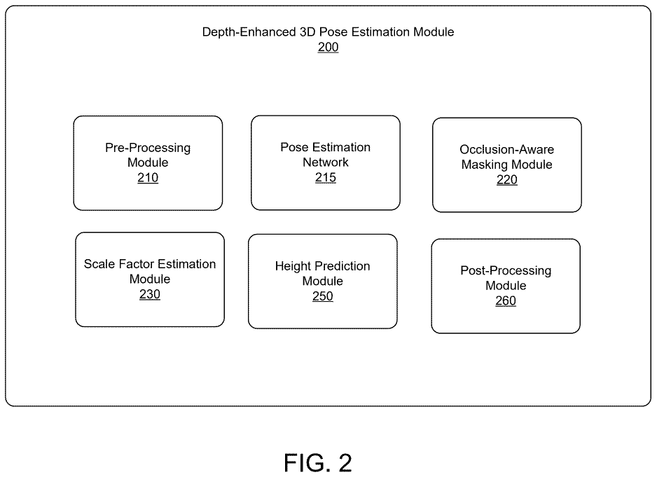

FIG. 2 illustrates one embodiment of a depth-enhanced 3D pose estimation module 200 that can enhance the accuracy and robustness of 3D human pose estimation by integrating depth information into the pose estimation process, in accordance with one embodiment. It should be understood that the embodiment of the depth-enhanced 3D pose estimation module 200 described herein is exemplary and that various other configurations are possible. The depth-enhanced 3D pose estimation module 200 may include more or fewer components than those illustrated, depending on the specific requirements and functionalities of the implementation. The scope of the present disclosure is intended to cover such modifications and variations as would be apparent to those skilled in the art. For instance, additional layers or modules may be incorporated to handle specific tasks or to improve the accuracy and robustness of the pose and size estimations. Conversely, certain components may be omitted or combined in some implementations without departing from the spirit and scope of the invention.

As illustrated in FIG. 2, a depth-enhanced 3D pose estimation module 200 may include several components that work together to achieve accurate 3D pose and size estimation. A depth-enhanced 3D pose estimation module 200 may include a pre-processing module 210 that performs preprocessing of input images such as the images captured by optical sensors, a pose estimation network 215 that generates an initial pose estimation based on RGBD data, an occlusion-aware masking module 220 that determines an occlusion score for body portions of occupants, a scale factor estimation module 230 that integrates the depth information with the occlusion-aware masks to estimate the absolute depth positions of key points, a height prediction model 250 that utilizes the scaled 3D pose and computed limb lengths to predict the height of occupants, and a post-processing module 260 that performs post-processing before the final outputs are generated. Each component is discussed in further detail below.

A pre-processing module 210 may perform one or more pre-processing tasks on the captured images and depth maps. Such pre-processing may involve various preparatory steps. In one embodiment, preprocessing may be performed both on the captured images and depth maps. A depth map may be generated based on depth data derived from the optical image data and ground truth depth data (such as a ground truth cabin depth image) corresponding to an interior of the vehicle. The ground truth cabin depth image corresponding to the interior of the vehicle may be generated in several ways. For example, in some embodiments, vehicle geometry specifications (e.g., CAD model information) on the geometry of the empty cars. In one embodiment, pre-processing may involve cropping the images and depth maps to focus on specific areas where occupants are likely to be located within the vehicle. This targeted cropping reduces the amount of data the system needs to process, which enhances computational efficiency and ensures that the analysis is centered on relevant parts of the image. For example, in a vehicle setting, the system might crop the image to focus where the occupants are situated and eliminate irrelevant background information. In one embodiment, input data may be normalized before being passed to a neural network. For example, the RGB channels of the image may be normalized, with the depth information not normalized. Normalization involves adjusting the pixel values in the image so that they fall within a standard range, such as between 0 and 1. Normalization may standardize the data input to the neural network, making the training process more stable and efficient. Normalized data may also help the neural network learn patterns more effectively and lead to better performance in tasks such as object detection and pose estimation.

The pre-processing module 210 may only normalize RGB channels but not the depth information. Depth maps provide data about the distance of objects from the camera. Normalizing depth data would alter the true scale of these measurements which may lead to inaccuracies in the subsequent analysis. Depth information is intentionally not normalized to reflect real-world dimensions accurately and to provide an absolute measure of distance. For instance, if a depth map shows that a person is 0.5 meters away from the camera, normalizing this data could distort that measurement and undermine the ability to accurately gauge the size and position of the occupant. By preserving the original scale of the depth information, the pre-processing module may ensure that the depth data remains a reliable reference point for subsequent stages of analysis.

The processed data may be passed to a pose estimation network 215 for an initial 3D pose estimation. A pose estimation network 215 is responsible for predicting the initial 3D pose of the occupant based on the processed RGBD (Red, Green, Blue, and Depth) data. A pose estimation network may utilize machine learning algorithms such as convolutional neural networks (CNNs) to process the four-channel RGBD input. Features that are indicative of the occupant's pose may be extracted and key points associated with an occupant may be identified. Based on the detected features (e.g., the cropped image) of the vehicle occupant, the pose estimation network 215 may generate the scale-normalized 3D pose of the occupant. The scale-normalized 3D pose may comprise a 3D representation of kinematic elements of the vehicle occupant (e.g., one or more body limbs and/or joints), and may indicate relative positions of using 3D coordinates for those kinematic elements. The pose estimation network 215 may comprise a machine learning model trained based on synchronized multi-view images of training subjects to produce the scale-normalized 3D pose. That is, the 3D coordinates are scale-normalized in that they may indicate the dimensions and/or relative positions of kinematic elements in relation to each other, rather than in absolute terms (e.g., linear measurement units). The scale-normalized pose estimation may be further adjusted by scaling functions in subsequent processing steps.

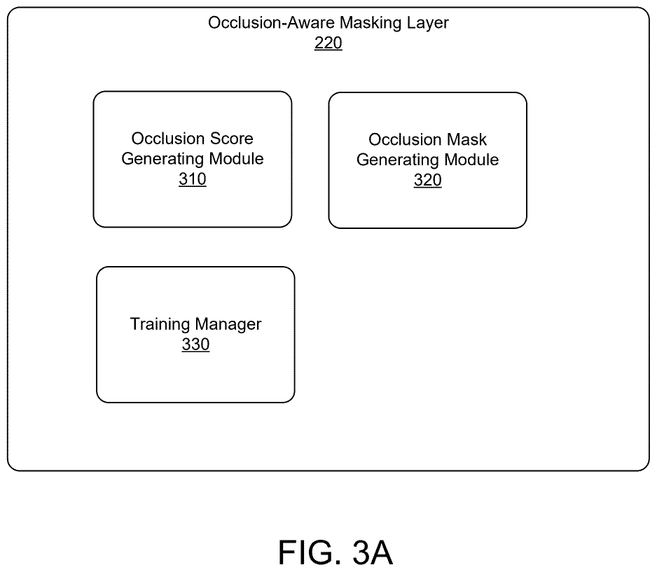

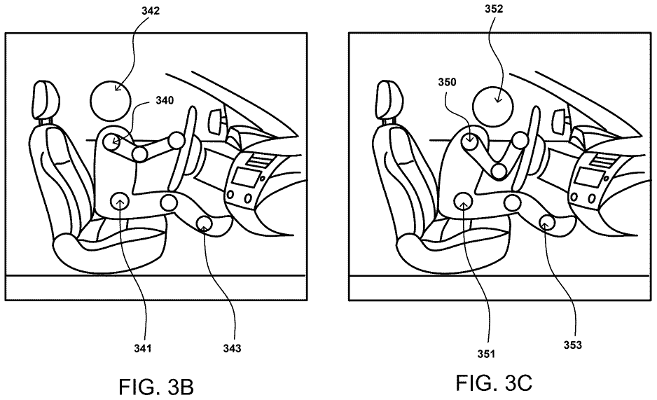

An occlusion-aware masking module 220 may generate occlusion-aware masks and occlusion scores for one or more key points, such as joints of the vehicle occupant. Key points, as used herein, may refer to anatomical landmarks on the human body, such as shoulders, elbows, knees, and hips. The key points may help with accurately modeling the pose of a person because they define structure and movement of human bodies. Occlusion scores may quantify the likelihood that a key point (such as a joint) is hidden or partially obscured by other objects or body parts. For example, in a sitting position, a person's elbow might be obscured (hidden behind) their torso or a knee might be obscured by a car seat. An occlusion-aware masking module 220 is discussed in detail in accordance with FIGS. 3A-3C.

FIG. 3A illustrates one embodiment of an occlusion-aware masking module 220 that includes multiple components, such as an occlusion score generating module 310, an occlusion mask generating module 320, and a training manager 330.

An occlusion score generating module 310 may evaluate the visibility of each key point and assigns an occlusion score accordingly. A higher occlusion score indicates a higher probability that the key point is hidden. Occlusion scores may be determined using heatmaps associated with the key points. A 2D heatmap may refer to a 2D Gaussian distribution centered around the predicted location of a key point. The spread of the Gaussian distribution indicates a confidence level in visibility associated with the key point. A more spread-out heatmap may suggest greater uncertainty and a higher likelihood of occlusion. As such, occlusion scores may be derived from the spread of the Gaussian heatmap where the more spread out the heat map is, the higher the occlusion score is.

An occlusion mask generating module 320 may generate occlusion masks based on the determined occlusion scores. Occlusion masks may represent weighting factors to be applied to the depth information for each key point during the 3D pose estimation process. The occlusion masks may adjust the contribution of each key point's depth information based on its occlusion score. For example, key points with higher occlusion scores (indicating higher likelihood of being hidden) receive lower weights in the occlusion masks. This reduces their impact on the final pose estimation. Conversely, key points with lower occlusion scores (indicating higher visibility) receive higher weights and their depth information may play a more significant role in determining the pose.

FIGS. 3B-3C show two example scenarios where key points and associated occlusion scores are illustrated for an occupant within a vehicle. In FIG. 3B, key points are indicated on the occupant, including the head 342, shoulder 340, root key point 341 (e.g., hip), ankle 343, and potentially other key points (such as elbow, hand, knee, etc.). A camera may be positioned on the dashboard facing the occupants. As illustrated, the occupant is sitting in an upright position. The head 342 and the shoulder 340 may receive lower occlusion scores, such as 0 or 1. Occlusion scores can be in various forms, such as discrete numbers, continuous values, or percentages. The hip 341 may receive a slightly higher score, such as 1 or 2, as it is partially obscured by the steering wheel. The ankle 343 may receive the highest score of 4 due to being more obscured. In this case, the depth information from the ankle 343 would receive a lower weight to reduce its influence on the overall pose and size estimation. Conversely, key points like the head 342 and shoulder 340, which are more likely to be clearly visible, will have lower occlusion scores. Higher weights may be assigned to these points such that depth information associated with these key points can play a more significant role in the pose estimation.

FIG. 3C shows the occupant in a different body position where the occupant is leaning forward. Because of the body position, the shoulder 350 may be partially occluded by the occupant's arm or head, resulting in a higher occlusion score compared to the one in FIG. 3B. Similarly, the hip 351 might also be more obscured and therefore receive a higher score. The ankle 353 remains hidden in both images and continues to receive a high occlusion score. Consequently, the occlusion mask for these key points will reduce their weighting in the pose estimation algorithm and the estimation may rely more on the visible key points, such as the head 352, which may have lower occlusion scores.

Continuing with the discussion of FIG. 3A, a training manager 330 may be responsible for the training of occasion-aware masking layers. Occlusion-aware masks can be learned—for example and without limitation—in a supervised manner or through weak supervision. The training manager 330 may train occlusion-aware masking layers using supervised learning when labeled data is available. In supervised learning, the training manager 330 may use labeled data where at least one (e.g., each) key point is marked as either visible or occluded. This labeled data allows the network to learn the patterns and correlations between key points and their occlusion statuses. For example, training data might include images where joints are manually annotated as visible or hidden, which help the network understand how to adjust the occlusion scores and corresponding masks. In scenarios where labeled data is insufficient, the training manager 330 may employ a weak supervision. Weak supervision uses relative depth information between joints to infer occlusion statuses. For instance, if the depth information indicates that one joint is significantly closer to the camera than another, the network might infer that the farther joint is likely occluded. This method allows the network to learn from less precise data, making it more flexible and capable of generalizing to new situations.

Referring back to FIG. 2, a scale factor estimation module 230 may integrate depth information with the pose estimation and occlusion-aware masks to estimate the absolute depth positions of key points. Relative 3D poses indicate the position of key points relative to each other but do not provide information about the actual size or distance of the occupant from the camera. A scale factor estimation module 230 may address this by deriving scale factors that adjust relative poses to match real-world dimensions. For instance, knowing the exact distance from the camera to the occupant's hip allows the system to scale the pose correctly and ensure that the estimated dimensions reflect the occupant's true size.

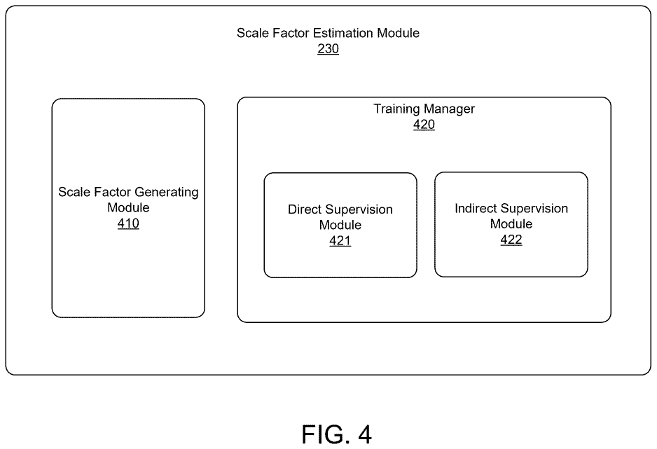

A scale factor estimation module 230 is discussed in detail in accordance with FIG. 4. As illustrated in FIG. 4, a scale factor estimation module 230 may include a scale factor generating module 410 and a training manager 420. A scale factor generating module 410 is tasked with computing scale factors that transform relative 3D pose data into absolute measurements. A scale factor generating module 410 may integrate depth information with occlusion-aware masks to estimate the absolute depth positions of key points (e.g., body joints). Unlike previous methods where an anchor point or root point (e.g., hip) is selected as a reference for scaling, a scale factor generating module 410 may utilize neural networks to determine scale factors based on the depth information of the whole body profile. In one embodiment, occlusion-aware masks may be used to help with weighting the depth information based on the visibility and reliability of each key point. For instance, if a particular joint, like the knee, is partially obscured, its depth information will be given less weight in the final calculation. With the weighted depth information, a scale factor generating module 410 may determine a single scale factor to be applied to the 3D pose. This factor is a conversion value that will adjust the relative 3D pose measurements into absolute 3D pose measurements.

A training manager 420 manages the training process of the scale factor estimation. A training manager 420 may train the corresponding neural network through a direct supervision module 421 or an indirect supervision module 422. A direct supervision module 421 may perform direct supervision on the training process by using labeled training data where ground truth absolute positions of key points are available. Ground truth data, which provides the exact locations of joint positions, can be challenging to obtain in real-world scenarios. To address this challenge, synthetic data can be utilized as a viable alternative. Synthetic datasets are generated through computer simulations where the exact positions of all joints are inherently known and can be controlled. This allows the training process to benefit from accurate and less expensive ground truth data even in the absence of ground truth data. A training manager may employ supervised learning techniques and utilize a mean squared error (MSE) between the scaled joint positions and their ground truth absolute positions as the loss function. By minimizing this error, the network learns to predict the correct scale factors.

On the other hand, an indirect supervision module 422 may handle situations where labeled ground truth data is unavailable. In scenarios where ground truth absolute positions are not available, the training process can still achieve accurate pose measurements using indirect supervision. Height estimation loss and limb estimation loss are two such methods. Height estimation loss uses the predicted height of the occupant as a reference to guide the scaling process. By comparing the estimated height with known anthropometric data, the system can adjust the scale factors to ensure the pose estimates are accurate. Similarly, limb estimation loss involves comparing the lengths of predicted limbs (such as the distance between the shoulder and elbow) with known data to refine the scale factors.

Continuing with the discussion of FIG. 2, a height prediction module 250 may utilize the scaled 3D pose to predict the height of the occupant. A height prediction model 250 may receive the scaled 3D pose data as input. This data includes the 3D coordinates of key body joints, such as the head, shoulders, elbows, hips, knees, and ankles, represented in real-world measurements. By having the 3D coordinates of the key points, a height prediction module 250 can calculate the lengths of various body limbs. For instance, the length of the upper arm is determined by measuring the distance between the shoulder and the elbow, while the length of the lower leg is calculated from the distance between the knee and the ankle. Once the limb lengths are computed, a height prediction module 250 proceeds to estimate the occupant's height. The height prediction involves aggregating the lengths of various body segments to form a complete estimate. For example, a height prediction module adds the lengths of the upper body (head to hip) and lower body (hip to feet) to derive the total height of the occupant. A height prediction module 250 may employ a fully connected neural network layer. The training of the neural network is guided by a height prediction loss function, which uses the mean squared error (MSE) between the predicted heights and the ground truth heights to guide the training process. By minimizing the MSE, the network learns to reduce the difference between the predicted height and the actual height to achieve high precision in the height estimations.

A post-processing module 260 may apply filtering and smoothing techniques to refine the pose and height estimates. The pose and height estimates may be refined to ensure accuracy and reliability before the final outputs are generated. Various filtering and smoothing techniques can be employed within the post-processing module 260, including but not limited to Kalman filtering, temporal smoothing, moving average filters, and Gaussian smoothing. For example, in the context of 3D pose estimation, a Kalman filter may predict the future positions of body joints based on previous observations and corrects these predictions using the current measurements. This process helps to smooth out sudden, unrealistic jumps in the estimated joint positions. As another example, temporal smoothing may be used to average the pose and height estimates over a sequence of frames to reduce the effect of any transient errors or noise. By considering multiple consecutive frames, outlier measurements that deviate significantly from the overall trend can be identified. In one embodiment, a mechanism is included for validating the consistency of the estimated pose and height data, such as checking the logical coherence of the estimated joint positions and limb lengths against known anatomical constraints. For example, the module ensures that the estimated distances between joints remain within realistic ranges and that the overall body proportions are consistent with human anatomy.

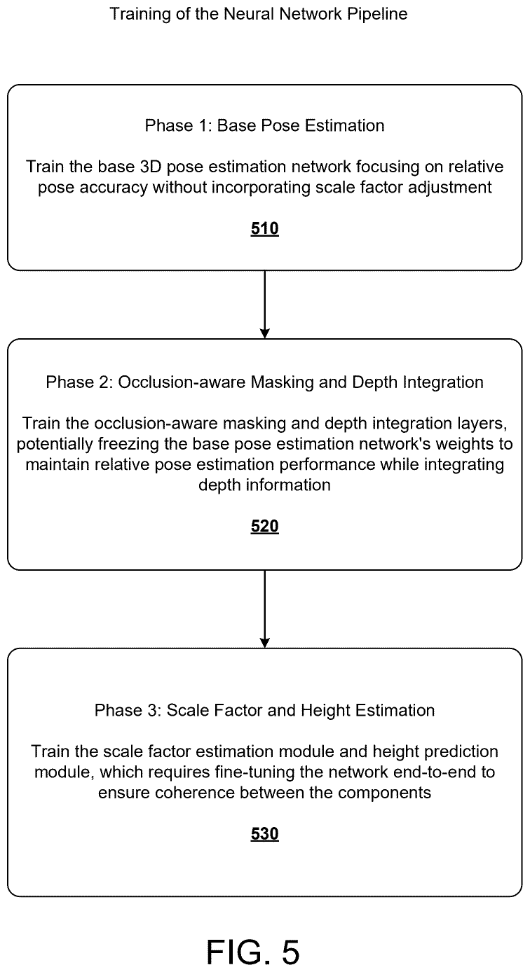

FIG. 5 illustrates an example training process of a neural network pipeline used for depth-guided 3D pose estimation and height prediction of vehicle occupants, in accordance with one embodiment. The training process may start with a first phase 510 that focuses on training the base 3D pose estimation network (e.g., the pose estimation network 215 in FIG. 2). During this phase of training, the pose estimation network may be trained without considering scale factor adjustments. The training may focus on accurately predicting relative poses. The weights trained during this phase may focus solely on optimizing the accuracy of relative pose estimations, which will serve as the groundwork for subsequent training phases. In a second training phase 520, the occlusion-aware masking and depth integration layers may be trained. This phase builds on the base pose estimation by introducing depth information into the network. During this stage, the weights of the base pose estimation network may be frozen to maintain its performance while the additional layers learn to handle occlusion and depth data. Additionally, the first convolutional layer may receive random weights to adapt to the new input channel configuration. The second phase 520 may stabilize the network by adjusting to the changes in input without disrupting the already learned relative pose estimation. In some embodiments, it is also possible to combine phase 1 and phase 2 if such a separate training approach does not significantly aid in network convergence. The third phase 530 may introduce training for the scale factor estimation block and the height prediction module. This phase may fine-tune the entire network end-to-end to ensure coherence and compatibility between all components utilizing ground truth data such as ground truth height and limb length data. During phase 3, the network may integrate all learned aspects, such as relative pose accuracy, depth integration, and occlusion handling, while incorporating scale factors to convert relative pose estimates into absolute measurements and predict occupant height accurately. The comprehensive training during phase 3 may further ensure that the network provides precise and reliable pose and height estimations for real-world applications.

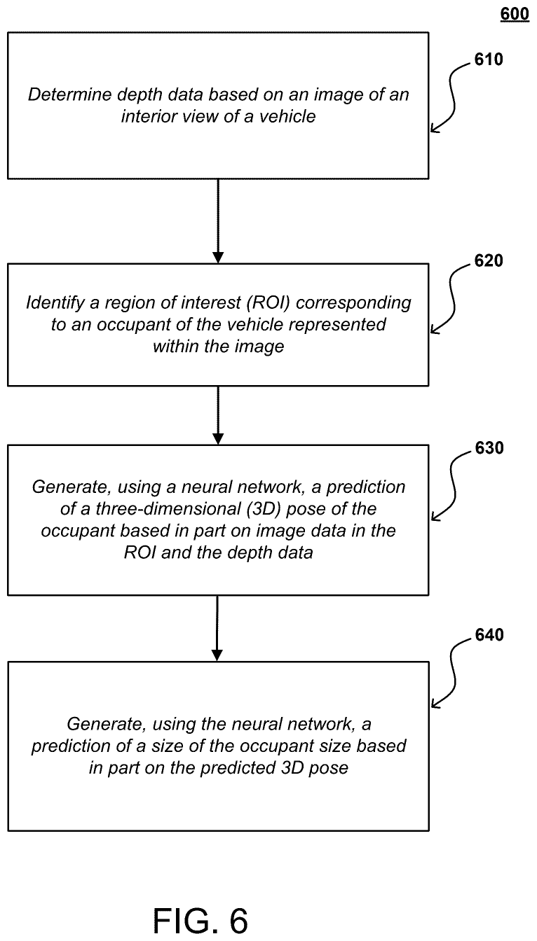

FIG. 6 illustrates an example process flow diagram 600 for estimating the three-dimensional (3D) pose and size of a vehicle occupant using a depth-enhanced size estimation system, in accordance with various embodiments of the present disclosure. The process may begin at step 610, where depth data is determined based on an image captured from the interior view of a vehicle. One or more optical sensors positioned within the vehicle may capture high-resolution Red, Green, Blue (RGB) images, which are then processed to generate corresponding depth maps. These depth maps provide information about the distance of objects within the image from the camera and enable the system to understand the spatial layout of the vehicle interior. At step 620, a region of interest (ROI) may be identified within the captured image that corresponds to the occupant of the vehicle. Step 620 may involve cropping the image and depth map to focus on the area where the occupant is located, forcing the neural networks to concentrate on the most interesting portions of the input images. In step 630, a neural network is employed to generate a prediction of the 3D pose of the occupant based on the input image and depth data. The neural network integrates image data from the ROI and the depth data to estimate the positions of key body joints in three-dimensional space. In one embodiment, a pose estimation network may process the combined four-channel input (RGBD) to produce an initial 3D pose estimation, which represents the spatial configuration of the occupant's body. An occlusion-aware masking layer may be incorporated to further refine the initial pose estimation by generating occlusion scores for at least one (e.g., each) joint and adjusting the weighting of the depth information accordingly, where joints likely to be occluded receive lower weights. In one embodiment, a scale factor estimation module may be applied to convert the relative 3D pose estimates into absolute measurements such that the dimensions are translated to absolute scales. Step 640 may involve generating a prediction of the size of the occupant using the neural network. The height prediction is based on the previously estimated 3D pose and may be performed by a neural network that is trained to predict heights (e.g., such as a height prediction module 250 from FIG. 2). A height prediction module may use the scaled measurements to predict the overall size of the occupant, such as their height.

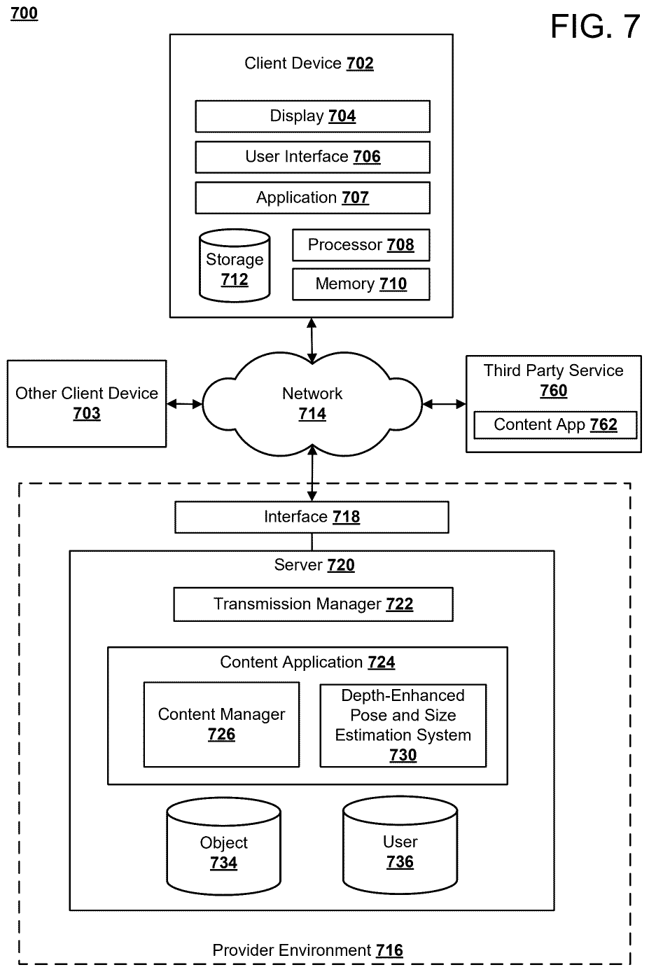

FIG. 7 illustrates an example networked system 700 that includes a depth-enhanced pose and size estimation system, in accordance with various embodiments. The example networked system 700 can be used to provide, generate, modify, encode, process, and/or transmit data or other content. The example networked system 700 may include a client device 702, other client device 703, a network 714, a third party service 760, and a provider environment 716 that includes a depth-enhanced pose and size estimation system 730.

The client device 702 may generate or receive data for a session using components of an application 707 on client device 702 and data stored locally on that client device 702. As an example, a user may utilize a client device 702 to perform depth-enhanced pose and size estimation using the application 707. Although only one client device 702 is illustrated in detail, the example networked system 700 may include one or more other client devices 703 that can communicate with the provider environment 716 through the network 714. A client device 702 may be any appropriate computing device capable of enabling a user to perform tasks related to depth-enhanced pose and size estimation as discussed herein, such as may include a desktop computer, notebook computer, computer workstation, gaming console, set-top box, streaming device, smartphone, tablet computer, VR headset, AR goggles, wearable computer, or a smart television. In at least one embodiment, a user can access functionality related to depth-enhanced pose and size estimation using a user interface (UI) 706 running on a client device 702, although at least some functionality may also operate on a remote device, networked device, or through a cloud computing platform. In at least one embodiment, a user can provide input to the UI 706, such as through a touch-sensitive display 704 or by moving a mouse cursor displayed on a display screen. In one embodiment, a user may be able to provide inputs such as preferences and configuration data to an application 707. The application 707 may be provided by the provider environment 716 for the user to download on the client device 702. In at least one embodiment, a client device can include at least one processor 708 (e.g., a CPU or GPU), a storage 712, and a memory 710 to execute application 707 and/or perform tasks on behalf of application 707.

In one embodiment, each client device 702 can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

The network 714 may represent the communication pathways among the client device 702, the provider environment 716, other client device 703, and the third party service 760. Through the network 714, the client device 702 may send input information associated with stream data processing over the network 714. The information may be received by a remote computing system, as may be part of a resource provider environment 716. In one embodiment, the network 714 is the Internet. The network 714 can include any appropriate network, including an intranet, Internet, a cellular network, a local area network (LAN), or any other such network or combination, and communication over a network can be enabled via wired and/or wireless connections. The network 714 can also utilize dedicated or private communication links that are not necessarily part of the Internet. In one embodiment, the network 714 uses standard communications technologies and/or protocols. Thus, the network 714 can include links using technologies such as Ethernet, Wi-Fi, integrated services digital network (ISDN), digital subscriber lines (DSL), asynchronous transfer mode (ATM), etc. Similarly, the networking protocols used on the network 714 can include multiprotocol label switching (MPLS), the transmission control protocol/Internet protocol (TCP/IP), the hypertext transport protocol (HTTP), the simple mail transfer protocol (SMTP), the file transfer protocol (FTP), etc. In one embodiment, at least some of the links use mobile networking technologies, such as long term evolution (LTE). The data exchanged over the network 714 can be represented using technologies or formats including the hypertext markup language (XML), the wireless access protocol (WAP), the short message service (SMS) etc. In addition, all or some of the links can be encrypted using conventional encryption technologies such as the secure sockets layer (SSL), secure HTTP or virtual private networks (VPNs). In another embodiment, the client device 702 can use custom and/or dedicated data communications technologies instead of, or in addition to, the ones described above.

The provider environment 716 may include any appropriate components for receiving requests and returning information or performing actions in response to those requests. In the embodiment illustrated in FIG. 7, the provider environment 716 may include an interface 718, and a server 720 that include various components for performing tasks associated with depth-enhanced pose and size estimation. In at least one embodiment, the provider environment 716 might include Web servers and/or application servers for receiving and processing requests, then returning data or other content or information in response to a request.

The interface 718 may receive communications to the server 720. In at least one embodiment, the interface 718 can include application programming interfaces (APIs) or other exposed interfaces enabling a user to submit requests to the server 720. In at least one embodiment, the interface 718 can include other components as well, such as at least one Web server, routing components, or load balancers. In at least one embodiment, components of an interface 718 can determine a type of request or communication, and can direct a request to an appropriate system or service such as a depth-enhanced pose and size estimation system 730.

The server 720 may include a transmission manager 722, a content application 724, an object repository 734, and a user database 736. The server 720 may receive requests and data from the client device 702, perform tasks associated with the requests, and send results or other data to the client device 702. In at least one embodiment, a content application 724 executing on the server 720 (e.g., a cloud server or edge server) may initiate a session associated with the client device 702, as may use a session manager and user data stored in a user database 736, and can cause content such as one or more object representations from an object repository 734 to be selected by a content manager 726 for processing. At least a portion of the generated content, such as results from stream data processing may be transmitted to the client device 702 using an appropriate transmission manager 722 to send by download, streaming, or another such transmission channel. An encoder may be used to encode and/or compress at least some of this data before transmitting to the client device 702. In at least one embodiment, the client device 702 receiving such content can provide this content to a corresponding application 707 for selecting, providing, synthesizing, modifying, or using content for presentation (or other purposes) on or by the client device 702. A decoder may also be used to decode data received over the network 714 for presentation via client device 702, such as image or video content through a touch-sensitive display 704. In at least one embodiment, at least some of the content may already be stored on, rendered on, or accessible to client device 702 such that transmission over the network 714 is not required for at least that portion of content, such as where the content may have been previously downloaded or stored locally on a hard drive or optical disk. In at least one embodiment, a transmission mechanism such as data streaming can be used to transfer the content from the server 720, or user database 736, to client device 702. In at least one embodiment, at least a portion of this content can be obtained, enhanced, and/or streamed from another source, such as a third party service 760 or other client device 703, that may also include a content application 762 for generating, enhancing, or providing content. In at least one embodiment, portions of this functionality can be performed using multiple computing devices, or multiple processors within one or more computing devices, such as may include a combination of CPUs and GPUs.

In at least one embodiment, the server 720 may include a processor such as a central processing unit (CPU). In at least one embodiment, however, resources in such environments can utilize GPUs to process data for at least certain types of requests. In at least one embodiment, with thousands of cores, GPUs are designed to handle substantial parallel workloads and, therefore, have become popular in deep learning for training neural networks and generating predictions. In at least one embodiment, while use of GPUs for offline builds has enabled faster training of larger and more complex models, generating predictions offline implies that either request-time input features cannot be used or predictions must be generated for all permutations of features and stored in a lookup table to serve real-time requests. In at least one embodiment, if a deep learning framework supports a CPU-mode and a model is small and simple enough to perform a feed-forward on a CPU with a reasonable latency, then a service on a CPU instance could host a model. In at least one embodiment, training can be done offline on a GPU and inference done in real-time on a CPU. In at least one embodiment, if a CPU approach is not a viable option, then a service can run on a GPU instance. In at least one embodiment, because GPUs have different performance and cost characteristics than CPUs, however, running a service that offloads a runtime algorithm to a GPU can require it to be designed differently from a CPU based service.

The server 720 may include a content application 724 that includes a content manager 726 and a depth-enhanced pose and size estimation system 730. As discussed previously, the content manager 726 may send objects, such as datasets and instructions, from the object repository 734 along with requests and other data from the client device 702 to a depth-enhanced pose and size estimation system 730 for stream data processing. A depth-enhanced pose and size estimation system 730 may process input data and provide the results to the transmission manager 722 for sending back to the client device 702. A depth-enhanced pose and size estimation system 730 may also use local datasets or datasets provided by the third party service 760 for stream data processing.

### Inference and Training Logic

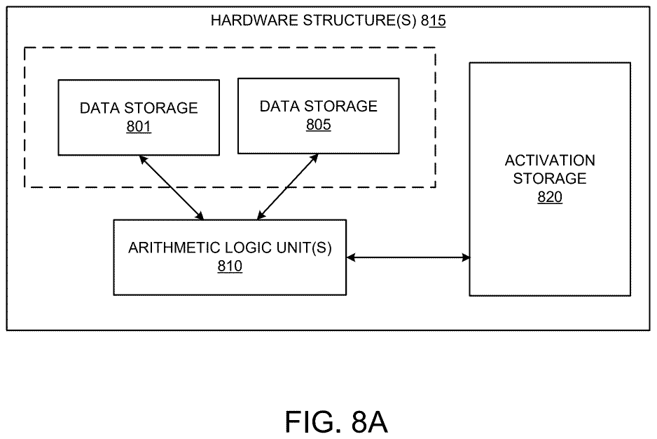

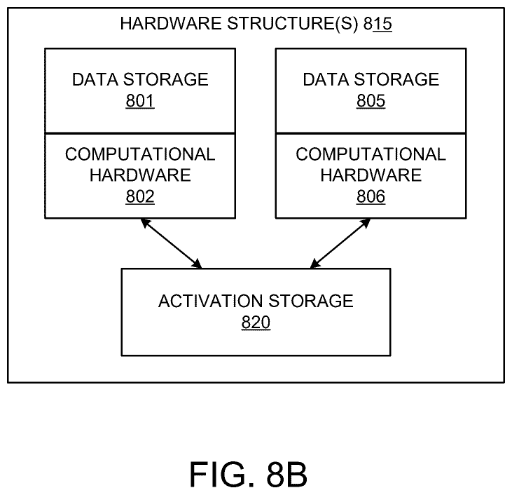

FIG. 8A illustrates inference and/or training logic 815 used to perform inferencing and/or training operations associated with one or more embodiments. Details regarding inference and/or training logic 815 are provided below in conjunction with FIGS. 8A and/or 8B.

In at least one embodiment, inference and/or training logic 815 may include, without limitation, code and/or data storage 801 to store forward and/or output weight and/or input/output data, and/or other parameters to configure neurons or layers of a neural network trained and/or used for inferencing in aspects of one or more embodiments. In at least one embodiment, training logic 815 may include, or be coupled to code and/or data storage 801 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 801 may be included with other on-chip or off-chip data storage, including a processor's L1, L2, or L3 cache or system memory.

In at least one embodiment, any portion of code and/or data storage 801 may be internal or external to one or more processors or other hardware logic devices or circuits. In at least one embodiment, code and/or data storage 801 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 801 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 815 may include, without limitation, a code and/or data storage 805 to store backward and/or output weight and/or input/output data corresponding to neurons or layers of a neural network trained and/or used for inferencing in aspects of one or more embodiments. In at least one embodiment, code and/or data storage 805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 815 may include, or be coupled to code and/or data storage 805 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 805 may be included with other on-chip or off-chip data storage, including a processor's L1, L2, or L3 cache or system memory. In at least one embodiment, any portion of code and/or data storage 805 may be internal or external to on one or more processors or other hardware logic devices or circuits. In at least one embodiment, code and/or data storage 805 may be cache memory, DRAM, SRAM, non-volatile memory (e.g., Flash memory), or other storage. In at least one embodiment, choice of whether code and/or data storage 805 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 801 and code and/or data storage 805 may be separate storage structures. In at least one embodiment, code and/or data storage 801 and code and/or data storage 805 may be same storage structure. In at least one embodiment, code and/or data storage 801 and code and/or data storage 805 may be partially same storage structure and partially separate storage structures. In at least one embodiment, any portion of code and/or data storage 801 and code and/or data storage 805 may be included with other on-chip or off-chip data storage, including a processor's L1, L2, or L3 cache or system memory.

In at least one embodiment, inference and/or training logic 815 may include, without limitation, one or more arithmetic logic unit(s) (“ALU(s)”) 810, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 820 that are functions of input/output and/or weight parameter data stored in code and/or data storage 801 and/or code and/or data storage 805. In at least one embodiment, activations stored in activation storage 820 are generated according to linear algebraic and or matrix-based mathematics performed by ALU(s) 810 in response to performing instructions or other code, wherein weight values stored in code and/or data storage 805 and/or code and/or data storage 801 are used as operands along with other values, such as bias values, gradient information, momentum values, or other parameters or hyperparameters, any or all of which may be stored in code and/or data storage 805 or code and/or data storage 801 or another storage on or off-chip.

In at least one embodiment, ALU(s) 810 are included within one or more processors or other hardware logic devices or circuits, whereas in another embodiment, ALU(s) 810 may be external to a processor or other hardware logic device or circuit that uses them (e.g., a co-processor). In at least one embodiment, ALU(s) 810 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 801, code and/or data storage 805, and activation storage 820 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 820 may be cache memory, DRAM, SRAM, non-volatile memory (e.g., Flash memory), or other storage. In at least one embodiment, activation storage 820 may be completely or partially within or external to one or more processors or other logical circuits. In at least one embodiment, choice of whether activation storage 820 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 815 illustrated in FIG. 8A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8A may be used in conjunction with central processing unit (“CPU”) hardware, graphics processing unit (“GPU”) hardware or other hardware, such as field programmable gate arrays (“FPGAs”).

FIG. 8B illustrates inference and/or training logic 815, according to at least one or more embodiments. In at least one embodiment, inference and/or training logic 815 may include, without limitation, hardware logic in which computational resources are dedicated or otherwise exclusively used in conjunction with weight values or other information corresponding to one or more layers of neurons within a neural network. In at least one embodiment, inference and/or training logic 815 illustrated in FIG. 8B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8B may be used in conjunction with central processing unit (CPU) hardware, graphics processing unit (GPU) hardware or other hardware, such as field programmable gate arrays (FPGAs). In at least one embodiment, inference and/or training logic 815 includes, without limitation, code and/or data storage 801 and code and/or data storage 805, which may be used to store code (e.g., graph code), weight values and/or other information, including bias values, gradient information, momentum values, and/or other parameter or hyperparameter information. In at least one embodiment illustrated in FIG. 8B, each of code and/or data storage 801 and code and/or data storage 805 is associated with a dedicated computational resource, such as computational hardware 802 and computational hardware 806, respectively. In at least one embodiment, each of computational hardware 802 and computational hardware 806 comprises one or more ALUs that perform mathematical functions, such as linear algebraic functions, only on information stored in code and/or data storage 801 and code and/or data storage 805, respectively, result of which is stored in activation storage 820.

In at least one embodiment, each of code and/or data storage 801 and 805 and corresponding computational hardware 802 and 806, respectively, correspond to different layers of a neural network, such that resulting activation from one “storage/computational pair 801/802” of code and/or data storage 801 and computational hardware 802 is provided as an input to “storage/computational pair 805/806” of code and/or data storage 805 and computational hardware 806, in order to mirror conceptual organization of a neural network. In at least one embodiment, each of storage/computational pairs 801/802 and 805/806 may correspond to more than one neural network layer. In at least one embodiment, additional storage/computation pairs (not shown) subsequent to or in parallel with storage computation pairs 801/802 and 805/806 may be included in inference and/or training logic 815.

### Data Center

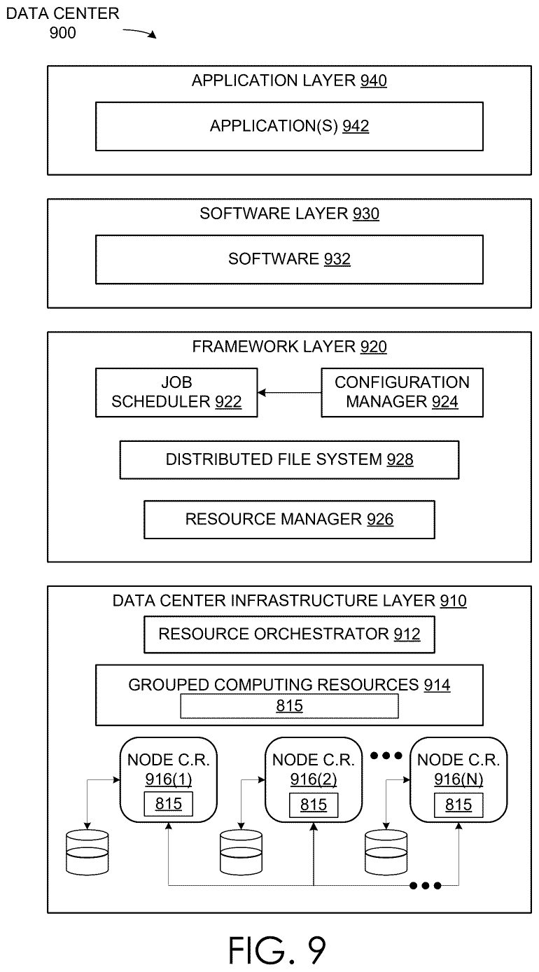

FIG. 9 illustrates an example data center 900, in which at least one embodiment may be used. In at least one embodiment, data center 900 includes a data center infrastructure layer 910, a framework layer 920, a software layer 930, and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 912 may configure or otherwise control one or more node C.R.s 916(1)-916(N) and/or grouped computing resources 914. In at least one embodiment, resource orchestrator 912 may include a software design infrastructure (“SDI”) management entity for data center 900. In at least one embodiment, resource orchestrator 912 may include hardware, software or some combination thereof.

In at least one embodiment, as shown in FIG. 9, framework layer 920 includes a job scheduler 922, a configuration manager 924, a resource manager 926 and a distributed file system 928. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may use distributed file system 928 for large-scale data processing (e.g., “big data”). In at least one embodiment, job scheduler 922 may include a Spark driver to facilitate scheduling of workloads supported by various layers of data center 900. In at least one embodiment, configuration manager 924 may be capable of configuring different layers such as software layer 930 and framework layer 920 including Spark and distributed file system 928 for supporting large-scale data processing. In at least one embodiment, resource manager 926 may be capable of managing clustered or grouped computing resources mapped to or allocated for support of distributed file system 928 and job scheduler 922. In at least one embodiment, clustered or grouped computing resources may include grouped computing resource 914 at data center infrastructure layer 910. In at least one embodiment, resource manager 926 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 928 of framework layer 920. The one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 928 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 924, resource manager 926, and resource orchestrator 912 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 815 are used to perform inferencing and/or training operations associated with one or more embodiments. Details regarding inference and/or training logic 815 are provided below in conjunction with FIGS. 8A and/or 8B. In at least one embodiment, inference and/or training logic 815 may be used in system FIG. 9 for inferencing or predicting operations based, at least in part, on weight parameters calculated using neural network training operations, neural network functions and/or architectures, or neural network use cases described herein.

Such components can allow for real-time communication censoring for improved user experience.

### Computer Systems

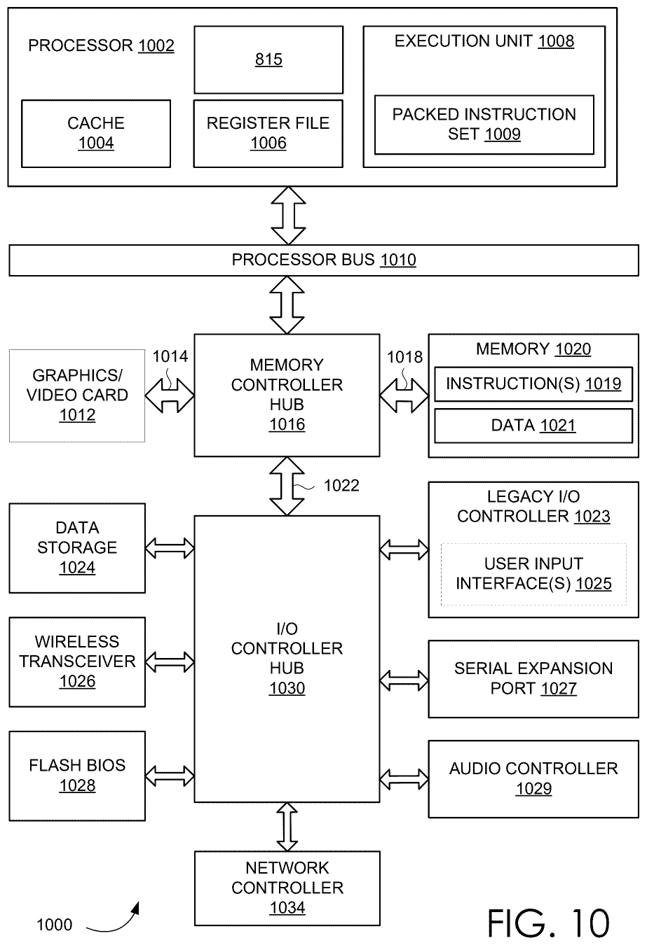

FIG. 10 is a block diagram illustrating an exemplary computer system, which may be a system with interconnected devices and components, a system-on-a-chip (SOC) or some combination thereof 1000 formed with a processor that may include execution units to execute an instruction, according to at least one embodiment. In at least one embodiment, computer system 1000 may include, without limitation, a component, such as a processor 1002 to employ execution units including logic to perform algorithms for process data, in accordance with present disclosure, such as in embodiment described herein. In at least one embodiment, computer system 1000 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1000 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 1000 may include, without limitation, processor 1002 that may include, without limitation, one or more execution units 1008 to perform machine learning model training and/or inferencing according to techniques described herein. In at least one embodiment, computer system 1000 is a single processor desktop or server system, but in another embodiment computer system 1000 may be a multiprocessor system. In at least one embodiment, processor 1002 may include, without limitation, a complex instruction set computing (“CISC”) microprocessor, a reduced instruction set computing (“RISC”) microprocessor, a very long instruction word (“VLIW”) computing microprocessor, a processor implementing a combination of instruction sets, or any other processor device, such as a digital signal processor, for example. In at least one embodiment, processor 1002 may be coupled to a processor bus 1010 that may transmit data signals between processor 1002 and other components in computer system 1000.

In at least one embodiment, processor 1002 may include, without limitation, a Level 1 (“L1”) internal cache memory (“cache”) 1004. In at least one embodiment, processor 1002 may have a single internal cache or multiple levels of internal cache. In at least one embodiment, cache memory may reside external to processor 1002. Other embodiments may also include a combination of both internal and external caches depending on particular implementation and needs. In at least one embodiment, register file 1006 may store different types of data in various registers including, without limitation, integer registers, floating point registers, status registers, and instruction pointer register.

In at least one embodiment, execution unit 1008, including, without limitation, logic to perform integer and floating point operations, also resides in processor 1002. In at least one embodiment, processor 1002 may also include a microcode (“ucode”) read only memory (“ROM”) that stores microcode for certain macro instructions. In at least one embodiment, execution unit 1008 may include logic to handle a packed instruction set 1009. In at least one embodiment, by including packed instruction set 1009 in an instruction set of a general-purpose processor 1002, along with associated circuitry to execute instructions, operations used by many multimedia applications may be performed using packed data in a general-purpose processor 1002. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 1008 may also be used in microcontrollers, embedded processors, graphics devices, DSPs, and other types of logic circuits. In at least one embodiment, computer system 1000 may include, without limitation, a memory 1020. In at least one embodiment, memory 1020 may be implemented as a Dynamic Random Access Memory (“DRAM”) device, a Static Random Access Memory (“SRAM”) device, flash memory device, or other memory device. In at least one embodiment, memory 1020 may store instruction(s) 1019 and/or data 1021 represented by data signals that may be executed by processor 1002.

In at least one embodiment, system logic chip may be coupled to processor bus 1010 and memory 1020. In at least one embodiment, system logic chip may include, without limitation, a memory controller hub (“MCH”) 1016, and processor 1002 may communicate with MCH 1016 via processor bus 1010. In at least one embodiment, MCH 1016 may provide a high bandwidth memory path 1018 to memory 1020 for instruction and data storage and for storage of graphics commands, data and textures. In at least one embodiment, MCH 1016 may direct data signals between processor 1002, memory 1020, and other components in computer system 1000 and to bridge data signals between processor bus 1010, memory 1020, and a system I/O 1022. In at least one embodiment, system logic chip may provide a graphics port for coupling to a graphics controller. In at least one embodiment, MCH 1016 may be coupled to memory 1020 through a high bandwidth memory path 1018 and graphics/video card 1012 may be coupled to MCH 1016 through an Accelerated Graphics Port (“AGP”) interconnect 1014.

In at least one embodiment, computer system 1000 may use system I/O 1022 that is a proprietary hub interface bus to couple MCH 1016 to I/O controller hub (“ICH”) 1030. In at least one embodiment, ICH 1030 may provide direct connections to some I/O devices via a local I/O bus. In at least one embodiment, local I/O bus may include, without limitation, a high-speed I/O bus for connecting peripherals to memory 1020, chipset, and processor 1002. Examples may include, without limitation, an audio controller 1029, a firmware hub (“flash BIOS”) 1028, a wireless transceiver 1026, a data storage 1024, a legacy I/O controller 1023 containing user input and keyboard interfaces 1025, a serial expansion port 1027, such as Universal Serial Bus (“USB”), and a network controller 1034. Data storage 1024 may comprise a hard disk drive, a floppy disk drive, a CD-ROM device, a flash memory device, or other mass storage device.

In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 1000 are interconnected using compute express link (CXL) interconnects.

Inference and/or training logic 815 are used to perform inferencing and/or training operations associated with one or more embodiments. Details regarding inference and/or training logic 815 are provided below in conjunction with FIGS. 8A and/or 8B. In at least one embodiment, inference and/or training logic 815 may be used in system FIG. 10 for inferencing or predicting operations based, at least in part, on weight parameters calculated using neural network training operations, neural network functions and/or architectures, or neural network use cases described herein.

Such components can allow for real-time communication censoring for improved user experience.

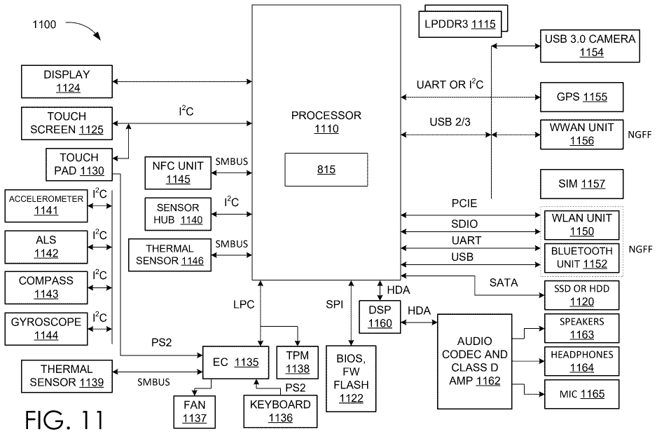

FIG. 11 is a block diagram illustrating an electronic device 1100 for utilizing a processor 1110, according to at least one embodiment. In at least one embodiment, electronic device 1100 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1100 may include, without limitation, processor 1110 communicatively coupled to any suitable number or kind of components, peripherals, modules, or devices. In at least one embodiment, processor 1110 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 11 illustrates a system, which includes interconnected hardware devices or “chips”, whereas in other embodiments, FIG. 11 may illustrate an exemplary System on a Chip (“SoC”). In at least one embodiment, devices illustrated in FIG. 11 may be interconnected with proprietary interconnects, standardized interconnects (e.g., PCIe) or some combination thereof. In at least one embodiment, one or more components of FIG. 11 are interconnected using compute express link (CXL) interconnects.

In at least one embodiment, FIG. 11 may include a display 1124, a touch screen 1125, a touch pad 1130, a Near Field Communications unit (“NFC”) 1145, a sensor hub 1140, a thermal sensor 1146, an Express Chipset (“EC”) 1135, a Trusted Platform Module (“TPM”) 1138, BIOS/firmware/flash memory (“BIOS, FW Flash”) 1122, a DSP 1160, a drive 1120 such as a Solid State Disk (“SSD”) or a Hard Disk Drive (“HDD”), a wireless local area network unit (“WLAN”) 1150, a Bluetooth unit 1152, a Wireless Wide Area Network unit (“WWAN”) 1156, a Global Positioning System (GPS) 1155, a camera (“USB 3.0 camera”) 1154 such as a USB 3.0 camera, and/or a Low Power Double Data Rate (“LPDDR”) memory unit (“LPDDR3”) 1115 implemented in, for example, LPDDR3 standard. These components may each be implemented in any suitable manner.

In at least one embodiment, other components may be communicatively coupled to processor 1110 through components discussed above. In at least one embodiment, an accelerometer 1141, Ambient Light Sensor (“ALS”) 1142, compass 1143, and a gyroscope 1144 may be communicatively coupled to sensor hub 1140. In at least one embodiment, thermal sensor 1139, a fan 1137, a keyboard 1136, and a touch pad 1130 may be communicatively coupled to EC 1135. In at least one embodiment, speakers 1163, headphones 1164, and microphone (“mic”) 1165 may be communicatively coupled to an audio unit (“audio codec and class d amp”) 1162, which may in turn be communicatively coupled to DSP 1160. In at least one embodiment, audio unit 1162 may include, for example and without limitation, an audio coder/decoder (“codec”) and a class D amplifier. In at least one embodiment, SIM card (“SIM”) 1157 may be communicatively coupled to WWAN unit 1156. In at least one embodiment, components such as WLAN unit 1150 and Bluetooth unit 1152, as well as WWAN unit 1156 may be implemented in a Next Generation Form Factor (“NGFF”).

Inference and/or training logic 815 are used to perform inferencing and/or training operations associated with one or more embodiments. Details regarding inference and/or training logic 815 are provided below in conjunction with FIGS. 8A and/or 8B. In at least one embodiment, inference and/or training logic 815 may be used in system FIG. 11 for inferencing or predicting operations based, at least in part, on weight parameters calculated using neural network training operations, neural network functions and/or architectures, or neural network use cases described herein.

Such components can allow for real-time communication censoring for improved user experience.

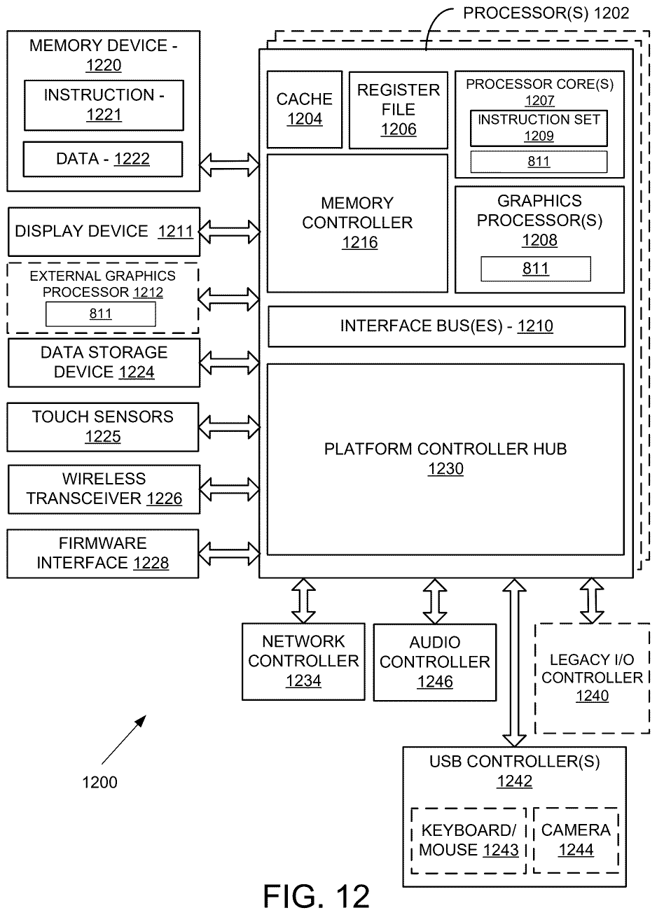

FIG. 12 is a block diagram of a processing system, according to at least one embodiment. In at least one embodiment, system 1200 includes one or more processor(s) 1202 and one or more graphics processor(s) 1208, and may be a single processor desktop system, a multiprocessor workstation system, or a server system having a large number of processor(s) 1202 or processor core(s) 1207. In at least one embodiment, system 1200 is a processing platform incorporated within a system-on-a-chip (SoC) integrated circuit for use in mobile, handheld, or embedded devices.

In at least one embodiment, system 1200 can include, or be incorporated within a server-based gaming platform, a game console, including a game and media console, a mobile gaming console, a handheld game console, or an online game console. In at least one embodiment, system 1200 is a mobile phone, smart phone, tablet computing device or mobile Internet device. In at least one embodiment, processing system 1200 can also include, coupled with, or be integrated within a wearable device, such as a smart watch wearable device, smart eyewear device, augmented reality device, or virtual reality device. In at least one embodiment, processing system 1200 is a television or set top box device having one or more processor(s) 1202 and a graphical interface generated by one or more graphics processor(s) 1208.

In at least one embodiment, one or more processor(s) 1202 each include one or more processor core(s) 1207 to process instructions which, when executed, perform operations for system and user software. In at least one embodiment, each of one or more processor core(s) 1207 is configured to process a specific instruction set 1209. In at least one embodiment, instruction set 1209 may facilitate Complex Instruction Set Computing (CISC), Reduced Instruction Set Computing (RISC), or computing via a Very Long Instruction Word (VLIW). In at least one embodiment, processor core(s) 1207 may each process a different instruction set 1209, which may include instructions to facilitate emulation of other instruction sets. In at least one embodiment, processor core(s) 1207 may also include other processing devices, such a Digital Signal Processor (DSP).

In at least one embodiment, processor(s) 1202 includes cache memory 1204. In at least one embodiment, processor(s) 1202 can have a single internal cache or multiple levels of internal cache. In at least one embodiment, cache memory is shared among various components of processor(s) 1202. In at least one embodiment, processor(s) 1202 also uses an external cache (e.g., a Level-3 (L3) cache or Last Level Cache (LLC)) (not shown), which may be shared among processor core(s) 1207 using known cache coherency techniques. In at least one embodiment, register file 1206 is additionally included in processor(s) 1202 which may include different types of registers for storing different types of data (e.g., integer registers, floating point registers, status registers, and an instruction pointer register). In at least one embodiment, register file 1206 may include general-purpose registers or other registers.

In at least one embodiment, one or more processor(s) 1202 are coupled with one or more interface bus(es) 1210 to transmit communication signals such as address, data, or control signals between processor(s) 1202 and other components in system 1200. In at least one embodiment, interface bus(es) 1210, in one embodiment, can be a processor bus, such as a version of a Direct Media Interface (DMI) bus. In at least one embodiment, interface bus(es) 1210 is not limited to a DMI bus, and may include one or more Peripheral Component Interconnect buses (e.g., PCI, PCI Express), memory busses, or other types of interface busses. In at least one embodiment processor(s) 1202 include an integrated memory controller 1216 and a platform controller hub 1230. In at least one embodiment, memory controller 1216 facilitates communication between a memory device and other components of system 1200, while platform controller hub (PCH) 1230 provides connections to I/O devices via a local I/O bus.

In at least one embodiment, memory device 1220 can be a dynamic random access memory (DRAM) device, a static random access memory (SRAM) device, flash memory device, phase-change memory device, or some other memory device having suitable performance to serve as process memory. In at least one embodiment memory device 1220 can operate as system memory for system 1200, to store data 1222 and instruction 1221 for use when one or more processor(s) 1202 executes an application or process. In at least one embodiment, memory controller 1216 also couples with an optional external graphics processor 1212, which may communicate with one or more graphics processor(s) 1208 in processor(s) 1202 to perform graphics and media operations. In at least one embodiment, a display device 1211 can connect to processor(s) 1202. In at least one embodiment display device 1211 can include one or more of an internal display device, as in a mobile electronic device or a laptop device or an external display device attached via a display interface (e.g., DisplayPort, etc.). In at least one embodiment, display device 1211 can include a head mounted display (HMD) such as a stereoscopic display device for use in virtual reality (VR) applications or augmented reality (AR) applications.

In at least one embodiment, platform controller hub 1230 enables peripherals to connect to memory device 1220 and processor(s) 1202 via a high-speed I/O bus. In at least one embodiment, I/O peripherals include, but are not limited to, an audio controller 1246, a network controller 1234, a firmware interface 1228, a wireless transceiver 1226, touch sensors 1225, a data storage device 1224 (e.g., hard disk drive, flash memory, etc.). In at least one embodiment, data storage device 1224 can connect via a storage interface (e.g., SATA) or via a peripheral bus, such as a Peripheral Component Interconnect bus (e.g., PCI, PCI Express). In at least one embodiment, touch sensors 1225 can include touch screen sensors, pressure sensors, or fingerprint sensors. In at least one embodiment, wireless transceiver 1226 can be a Wi-Fi transceiver, a Bluetooth transceiver, or a mobile network transceiver such as a 3G, 4G, or Long Term Evolution (LTE) transceiver. In at least one embodiment, firmware interface 1228 enables communication with system firmware, and can be, for example, a unified extensible firmware interface (UEFI). In at least one embodiment, network controller 1234 can enable a network connection to a wired network. In at least one embodiment, a high-performance network controller (not shown) couples with interface bus(es) 1210. In at least one embodiment, audio controller 1246 is a multi-channel high definition audio controller. In at least one embodiment, system 1200 includes an optional legacy I/O controller 1240 for coupling legacy (e.g., Personal System 2 (PS/2)) devices to system. In at least one embodiment, platform controller hub 1230 can also connect to one or more Universal Serial Bus (USB) controller(s) 1242 connect input devices, such as keyboard and mouse 1243 combinations, a camera 1244, or other USB input devices.

In at least one embodiment, an instance of memory controller 1216 and platform controller hub 1230 may be integrated into a discreet external graphics processor, such as external graphics processor 1212. In at least one embodiment, platform controller hub 1230 and/or memory controller 1216 may be external to one or more processor(s) 1202. For example, in at least one embodiment, system 1200 can include an external memory controller 1216 and platform controller hub 1230, which may be configured as a memory controller hub and peripheral controller hub within a system chipset that is in communication with processor(s) 1202.

Inference and/or training logic 815 are used to perform inferencing and/or training operations associated with one or more embodiments. Details regarding inference and/or training logic 815 are provided below in conjunction with FIGS. 8A and/or 8B. In at least one embodiment portions or all of inference and/or training logic 815 may be incorporated into system 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 8A and/or 8B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can allow for real-time communication censoring for improved user experience.

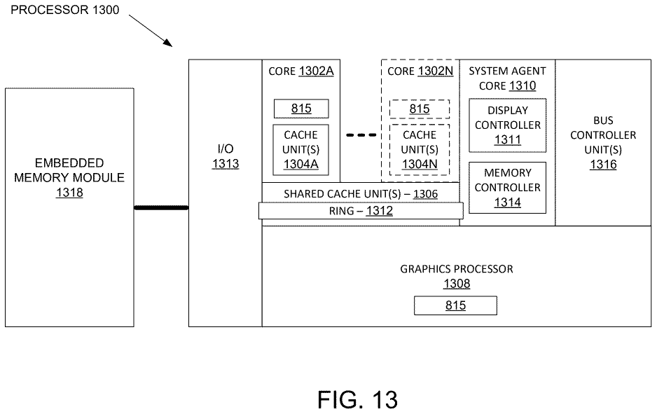

FIG. 13 is a block diagram of a processor 1300 having one or more processor core(s) 1302A-1302N, an integrated memory controller 1314, and an integrated graphics processor 1308, according to at least one embodiment. In at least one embodiment, processor 1300 can include additional cores up to and including additional core 1302N represented by dashed lined boxes. In at least one embodiment, each of processor core(s) 1302A-1302N includes one or more internal cache unit(s) 1304A-1304N. In at least one embodiment, each processor core also has access to one or more shared cached unit(s) 1306.

In at least one embodiment, internal cache unit(s) 1304A-1304N and shared cache unit(s) 1306 represent a cache memory hierarchy within processor 1300. In at least one embodiment, cache unit(s) 1304A-1304N may include at least one level of instruction and data cache within each processor core and one or more levels of shared mid-level cache, such as a Level 2 (L2), Level 3 (L3), Level 4 (LA), or other levels of cache, where a highest level of cache before external memory is classified as an LLC. In at least one embodiment, cache coherency logic maintains coherency between various cache unit(s) 1306 and 1304A-1304N.

In at least one embodiment, processor 1300 may also include a set of one or more bus controller unit(s) 1316 and a system agent core 1310. In at least one embodiment, one or more bus controller unit(s) 1316 manage a set of peripheral buses, such as one or more PCI or PCI express busses. In at least one embodiment, system agent core 1310 provides management functionality for various processor components. In at least one embodiment, system agent core 1310 includes one or more integrated memory controllers 1314 to manage access to various external memory devices (not shown).

In at least one embodiment, one or more of processor core(s) 1302A-1302N include support for simultaneous multi-threading. In at least one embodiment, system agent core 1310 includes components for coordinating and processor core(s) 1302A-1302N during multi-threaded processing. In at least one embodiment, system agent core 1310 may additionally include a power control unit (PCU), which includes logic and components to regulate one or more power states of processor core(s) 1302A-1302N and graphics processor 1308.

In at least one embodiment, processor 1300 additionally includes graphics processor 1308 to execute graphics processing operations. In at least one embodiment, graphics processor 1308 couples with shared cache unit(s) 1306, and system agent core 1310, including one or more integrated memory controllers 1314. In at least one embodiment, system agent core 1310 also includes a display controller 1311 to drive graphics processor output to one or more coupled displays. In at least one embodiment, display controller 1311 may also be a separate module coupled with graphics processor 1308 via at least one interconnect, or may be integrated within graphics processor 1308.

In at least one embodiment, a ring based interconnect unit 1312 is used to couple internal components of processor 1300. In at least one embodiment, an alternative interconnect unit may be used, such as a point-to-point interconnect, a switched interconnect, or other techniques. In at least one embodiment, graphics processor 1308 couples with a ring based interconnect unit 1312 via an I/O link 1313.

In at least one embodiment, I/O link 1313 represents at least one of multiple varieties of I/O interconnects, including an on package I/O interconnect which facilitates communication between various processor components and a high-performance embedded memory module 1318, such as an eDRAM module. In at least one embodiment, each of processor core(s) 1302A-1302N and graphics processor 1308 use embedded memory modules 1318 as a shared Last Level Cache.

In at least one embodiment, processor core(s) 1302A-1302N are homogenous cores executing a common instruction set architecture. In at least one embodiment, processor core(s) 1302A-1302N are heterogeneous in terms of instruction set architecture (ISA), where one or more of processor core(s) 1302A-1302N execute a common instruction set, while one or more other cores of processor core(s) 1302A-1302N executes a subset of a common instruction set or a different instruction set. In at least one embodiment, processor core(s) 1302A-1302N are heterogeneous in terms of microarchitecture, where one or more cores having a relatively higher power consumption couple with one or more power cores having a lower power consumption. In at least one embodiment, processor 1300 can be implemented on one or more chips or as an SoC integrated circuit.

Inference and/or training logic 815 are used to perform inferencing and/or training operations associated with one or more embodiments. Details regarding inference and/or training logic 815 are provided below in conjunction with FIGS. 8A and/or 8B. In at least one embodiment portions or all of inference and/or training logic 815 may be incorporated into processor 1300. For example, in at least one embodiment, training and/or inferencing techniques described herein may use one or more of ALUs embodied in graphics processor 1308, graphics core(s) 1302A-1302N, or other components in FIG. 13. Moreover, in at least one embodiment, inferencing and/or training operations described herein may be done using logic other than logic illustrated in FIGS. 8A and/or 8B. In at least one embodiment, weight parameters may be stored in on-chip or off-chip memory and/or registers (shown or not shown) that configure ALUs of graphics processor 1300 to perform one or more machine learning algorithms, neural network architectures, use cases, or training techniques described herein.

Such components can allow for real-time communication censoring for improved user experience.

### Virtualized Computing Platform

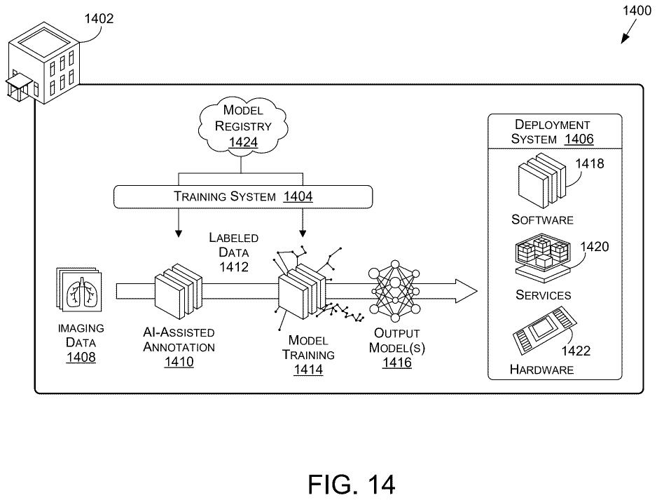

FIG. 14 is an example data flow diagram for a process 1400 of generating and deploying an image processing and inferencing pipeline, in accordance with at least one embodiment. In at least one embodiment, process 1400 may be deployed for use with imaging devices, processing devices, and/or other device types at one or more facilities 1402. Process 1400 may be executed within a training system 1404 and/or a deployment system 1406. In at least one embodiment, training system 1404 may be used to perform training, deployment, and implementation of machine learning models (e.g., neural networks, object detection algorithms, computer vision algorithms, etc.) for use in deployment system 1406. In at least one embodiment, deployment system 1406 may be configured to offload processing and compute resources among a distributed computing environment to reduce infrastructure requirements at facility 1402. In at least one embodiment, one or more applications in a pipeline may use or call upon services (e.g., inference, visualization, compute, AI, etc.) of deployment system 1406 during execution of applications.

In at least one embodiment, some of applications used in advanced processing and inferencing pipelines may use machine learning models or other AI to perform one or more processing steps. In at least one embodiment, machine learning models may be trained at facility 1402 using data 1408 (such as imaging data) generated at facility 1402 (and stored on one or more picture archiving and communication system (PACS) servers at facility 1402), may be trained using imaging or sequencing data 1408 from another facility(ies), or a combination thereof. In at least one embodiment, training system 1404 may be used to provide applications, services, and/or other resources for generating working, deployable machine learning models for deployment system 1306.

In at least one embodiment, model registry 1424 may be backed by object storage that may support versioning and object metadata. In at least one embodiment, object storage may be accessible through, for example, a cloud storage compatible application programming interface (API) from within a cloud platform. In at least one embodiment, machine learning models within model registry 1424 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1404 (FIG. 14) may include a scenario where facility 1402 is training their own machine learning model, or has an existing machine learning model that needs to be optimized or updated. In at least one embodiment, imaging data 1408 generated by imaging device(s), sequencing devices, and/or other device types may be received. In at least one embodiment, once imaging data 1408 is received, AI-assisted annotation 1410 may be used to aid in generating annotations corresponding to imaging data 1408 to be used as ground truth data for a machine learning model. In at least one embodiment, AI-assisted annotation 1410 may include one or more machine learning models (e.g., convolutional neural networks (CNNs)) that may be trained to generate annotations corresponding to certain types of imaging data 1408 (e.g., from certain devices). In at least one embodiment, AI-assisted annotation 1410 may then be used directly, or may be adjusted or fine-tuned using an annotation tool to generate ground truth data. In at least one embodiment, AI-assisted annotation 1410, labeled data 1412, or a combination thereof may be used as ground truth data for training a machine learning model. In at least one embodiment, a trained machine learning model may be referred to as output model(s) 1416, and may be used by deployment system 1406, as described herein.

In at least one embodiment, a training pipeline may include a scenario where facility 1402 needs a machine learning model for use in performing one or more processing tasks for one or more applications in deployment system 1406, but facility 1402 may not currently have such a machine learning model (or may not have a model that is optimized, efficient, or effective for such purposes). In at least one embodiment, an existing machine learning model may be selected from a model registry 1424. In at least one embodiment, model registry 1424 may include machine learning models trained to perform a variety of different inference tasks on imaging data. In at least one embodiment, machine learning models in model registry 1424 may have been trained on imaging data from different facilities than facility 1402 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1424. In at least one embodiment, a machine learning model may then be retrained, or updated, at any number of other facilities, and a retrained or updated model may be made available in model registry 1424. In at least one embodiment, a machine learning model may then be selected from model registry 1424—and referred to as output model(s) 1416—and may be used in deployment system 1406 to perform one or more processing tasks for one or more applications of a deployment system.

In at least one embodiment, a scenario may include facility 1402 requiring a machine learning model for use in performing one or more processing tasks for one or more applications in deployment system 1406, but facility 1402 may not currently have such a machine learning model (or may not have a model that is optimized, efficient, or effective for such purposes). In at least one embodiment, a machine learning model selected from model registry 1424 may not be fine-tuned or optimized for imaging data 1408 generated at facility 1402 because of differences in populations, robustness of training data used to train a machine learning model, diversity in anomalies of training data, and/or other issues with training data. In at least one embodiment, AI-assisted annotation 1410 may be used to aid in generating annotations corresponding to imaging data 1408 to be used as ground truth data for retraining or updating a machine learning model. In at least one embodiment, labeled data 1412 may be used as ground truth data for training a machine learning model. In at least one embodiment, retraining or updating a machine learning model may be referred to as model training 1414. In at least one embodiment, model training 1414—e.g., AI-assisted annotation 1410, labeled data 1412, or a combination thereof—may be used as ground truth data for retraining or updating a machine learning model. In at least one embodiment, a trained machine learning model may be referred to as output model(s) 1416, and may be used by deployment system 1406, as described herein.

In at least one embodiment, deployment system 1406 may include software 1418, services 1420, hardware 1422, and/or other components, features, and functionality. In at least one embodiment, deployment system 1406 may include a software “stack,” such that software 1418 may be built on top of services 1420 and may use services 1420 to perform some or all of processing tasks, and services 1420 and software 1418 may be built on top of hardware 1422 and use hardware 1422 to execute processing, storage, and/or other compute tasks of deployment system 1406. In at least one embodiment, software 1418 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1408, in addition to containers that receive and configure imaging data for use by each container and/or for use by facility 1402 after processing through a pipeline (e.g., to convert outputs back to a usable data type). In at least one embodiment, a combination of containers within software 1418 (e.g., that make up a pipeline) may be referred to as a virtual instrument (as described in more detail herein), and a virtual instrument may leverage services 1420 and hardware 1422 to execute some or all processing tasks of applications instantiated in containers.

In at least one embodiment, a data processing pipeline may receive input data (e.g., imaging data 1408) in a specific format in response to an inference request (e.g., a request from a user of deployment system 1406). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1416 of training system 1404.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1424 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1420 as a system (e.g., processor 1300 of FIG. 13). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by process 1400 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., process 1400 of FIG. 14). In at least one embodiment, completed and validated applications or containers may be stored in a container registry and associated machine learning models may be stored in model registry 1424. In at least one embodiment, a requesting entity—who provides an inference or image processing request—may browse a container registry and/or model registry 1424 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1406 (e.g., a cloud) to perform processing of data processing pipeline. In at least one embodiment, processing by deployment system 1406 may include referencing selected elements (e.g., applications, containers, models, etc.) from a container registry and/or model registry 1424. In at least one embodiment, once results are generated by a pipeline, results may be returned to a user for reference (e.g., for viewing in a viewing application suite executing on a local, on-premises workstation or terminal).

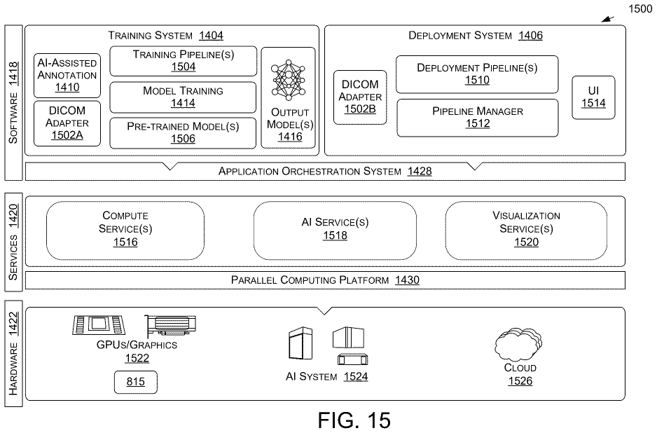

In at least one embodiment, to aid in processing or execution of applications or containers in pipelines, services 1420 may be leveraged. In at least one embodiment, services 1420 may include compute services, artificial intelligence (AI) services, visualization services, and/or other service types. In at least one embodiment, services 1420 may provide functionality that is common to one or more applications in software 1418, so functionality may be abstracted to a service that may be called upon or leveraged by applications. In at least one embodiment, functionality provided by services 1420 may run dynamically and more efficiently, while also scaling well by allowing applications to process data in parallel (e.g., using a parallel computing platform 1530 (FIG. 15)). In at least one embodiment, rather than each application that shares a same functionality offered by services 1320 being required to have a respective instance of services 1420, services 1420 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1420 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1418 implementing advanced processing and inferencing pipeline that includes segmentation application and anomaly detection application may be streamlined because each application may call upon a same inference service to perform one or more inferencing tasks.

In at least one embodiment, hardware 1422 may include GPUs, CPUs, graphics cards, an AI/deep learning system (e.g., an AI supercomputer, such as NVIDIA's DGX), a cloud platform, or a combination thereof. In at least one embodiment, different types of hardware 1422 may be used to provide efficient, purpose-built support for software 1418 and services 1420 in deployment system 1406. In at least one embodiment, use of GPU processing may be implemented for processing locally (e.g., at facility 1402), within an AI/deep learning system, in a cloud system, and/or in other processing components of deployment system 1406 to improve efficiency, accuracy, and efficacy of image processing and generation. In at least one embodiment, software 1418 and/or services 1420 may be optimized for GPU processing with respect to deep learning, machine learning, and/or high-performance computing, as non-limiting examples. In at least one embodiment, at least some of computing environment of deployment system 1406 and/or training system 1404 may be executed in a datacenter one or more supercomputers or high performance computing systems, with GPU optimized software (e.g., hardware and software combination of NVIDIA's DGX System). In at least one embodiment, hardware 1422 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 15 is a system diagram for an example system 1500 for generating and deploying an imaging deployment pipeline, in accordance with at least one embodiment. In at least one embodiment, system 1500 may be used to implement process 1400 of FIG. 14 and/or other processes including advanced processing and inferencing pipelines. In at least one embodiment, system 1500 may include training system 1404 and deployment system 1406. In at least one embodiment, training system 1404 and deployment system 1406 may be implemented using software 1418, services 1420, and/or hardware 1422, as described herein.

In at least one embodiment, system 1500 (e.g., training system 1404 and/or deployment system 1406) may implemented in a cloud computing environment (e.g., using cloud 1526). In at least one embodiment, system 1500 may be implemented locally with respect to a healthcare services facility, or as a combination of both cloud and local computing resources. In at least one embodiment, access to APIs in cloud 1526 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1500, may be restricted to a set of public IPs that have been vetted or authorized for interaction.

In at least one embodiment, various components of system 1500 may communicate between and among one another using any of a variety of different network types, including but not limited to local area networks (LANs) and/or wide area networks (WANs) via wired and/or wireless communication protocols. In at least one embodiment, communication between facilities and components of system 1500 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1404 may execute training pipelines 1504, similar to those described herein with respect to FIG. 14. In at least one embodiment, where one or more machine learning models are to be used in deployment pipeline(s) 1510 by deployment system 1406, training pipelines 1504 may be used to train or retrain one or more (e.g. pre-trained) models, and/or implement one or more of pre-trained models 1506 (e.g., without a need for retraining or updating). In at least one embodiment, as a result of training pipelines 1504, output model(s) 1416 may be generated. In at least one embodiment, training pipelines 1504 may include any number of processing steps, such as but not limited to imaging data (or other input data) conversion or adaption In at least one embodiment, for different machine learning models used by deployment system 1406, different training pipelines 1504 may be used. In at least one embodiment, training pipeline 1504 similar to a first example described with respect to FIG. 14 may be used for a first machine learning model, training pipeline 1504 similar to a second example described with respect to FIG. 14 may be used for a second machine learning model, and training pipeline 1504 similar to a third example described with respect to FIG. 14 may be used for a third machine learning model. In at least one embodiment, any combination of tasks within training system 1404 may be used depending on what is required for each respective machine learning model. In at least one embodiment, one or more of machine learning models may already be trained and ready for deployment so machine learning models may not undergo any processing by training system 1404, and may be implemented by deployment system 1406.

In at least one embodiment, output model(s) 1416 and/or pre-trained models 1506 may include any types of machine learning models depending on implementation or embodiment. In at least one embodiment, and without limitation, machine learning models used by system 1500 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1504 may include AI-assisted annotation, as described in more detail herein with respect to at least FIG. 15B. In at least one embodiment, labeled data 1412 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1408 (or other data type used by machine learning models), there may be corresponding ground truth data generated by training system 1404. In at least one embodiment, AI-assisted annotation may be performed as part of deployment pipeline(s) 1510; either in addition to, or in lieu of AI-assisted annotation included in training pipelines 1504. In at least one embodiment, system 1500 may include a multi-layer platform that may include a software layer (e.g., software 1418) of diagnostic applications (or other application types) that may perform one or more medical imaging and diagnostic functions. In at least one embodiment, system 1500 may be communicatively coupled to (e.g., via encrypted links) PACS server networks of one or more facilities. In at least one embodiment, system 1500 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1402). In at least one embodiment, applications may then call or execute one or more services 1420 for performing compute, AI, or visualization tasks associated with respective applications, and software 1418 and/or services 1420 may leverage hardware 1422 to perform processing tasks in an effective and efficient manner. In at least one embodiment, communications sent to, or received by, a training system 1404 and a deployment system 1306 may occur using a pair of DICOM adapters 1502A, 1502B.

In at least one embodiment, deployment system 1406 may execute deployment pipeline(s) 1510. In at least one embodiment, deployment pipeline(s) 1510 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1510 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1510 depending on information desired from data generated by a device. In at least one embodiment, where detections of anomalies are desired from an MRI machine, there may be a first deployment pipeline(s) 1510, and where image enhancement is desired from output of an MRI machine, there may be a second deployment pipeline(s) 1510.

In at least one embodiment, an image generation application may include a processing task that includes use of a machine learning model. In at least one embodiment, a user may desire to use their own machine learning model, or to select a machine learning model from model registry 1424. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1500—such as services 1420 and hardware 1422—deployment pipeline(s) 1510 may be even more user friendly, provide for easier integration, and produce more accurate, efficient, and timely results.

In at least one embodiment, deployment system 1406 may include a user interface (“UI”) 1514 (e.g., a graphical user interface, a web interface, etc.) that may be used to select applications for inclusion in deployment pipeline(s) 1510, arrange applications, modify or change applications or parameters or constructs thereof, use and interact with deployment pipeline(s) 1510 during set-up and/or deployment, and/or to otherwise interact with deployment system 1406. In at least one embodiment, although not illustrated with respect to training system 1404, UI 1514 (or a different user interface) may be used for selecting models for use in deployment system 1406, for selecting models for training, or retraining, in training system 1404, and/or for otherwise interacting with training system 1404.

In at least one embodiment, pipeline manager 1512 may be used, in addition to an application orchestration system 1528, to manage interaction between applications or containers of deployment pipeline(s) 1510 and services 1420 and/or hardware 1422. In at least one embodiment, pipeline manager 1512 may be configured to facilitate interactions from application to application, from application to services 1420, and/or from application or service to hardware 1422. In at least one embodiment, although illustrated as included in software 1418, this is not intended to be limiting, and in some examples pipeline manager 1512 may be included in services 1420. In at least one embodiment, application orchestration system 1528 (e.g., Kubernetes, DOCKER, etc.) may include a container orchestration system that may group applications into containers as logical units for coordination, management, scaling, and deployment. In at least one embodiment, by associating applications from deployment pipeline(s) 1510 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1512 and application orchestration system 1528. In at least one embodiment, so long as an expected input and/or output of each container or application is known by a system (e.g., based on constructs of applications or containers), application orchestration system 1528 and/or pipeline manager 1512 may facilitate communication among and between, and sharing of resources among and between, each of applications or containers. In at least one embodiment, because one or more of applications or containers in deployment pipeline(s) 1510 may share same services and resources, application orchestration system 1528 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1528) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1420 leveraged by and shared by applications or containers in deployment system 1406 may include compute service(s) 1516, AI service(s) 1518, visualization service(s) 1520, and/or other service types. In at least one embodiment, applications may call (e.g., execute) one or more of services 1420 to perform processing operations for an application. In at least one embodiment, compute service(s) 1516 may be leveraged by applications to perform super-computing or other high-performance computing (HPC) tasks. In at least one embodiment, compute service(s) 1516 may be leveraged to perform parallel processing (e.g., using a parallel computing platform 1530) for processing data through one or more of applications and/or one or more tasks of a single application, substantially simultaneously. In at least one embodiment, parallel computing platform 1530 (e.g., NVIDIA's CUDA) may enable general purpose computing on GPUs (GPGPU) (e.g., GPUs/Graphics 1522). In at least one embodiment, a software layer of parallel computing platform 1530 may provide access to virtual instruction sets and parallel computational elements of GPUs, for execution of compute kernels. In at least one embodiment, parallel computing platform 1530 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1530 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1518 may be leveraged to perform inferencing services for executing machine learning model(s) associated with applications (e.g., tasked with performing one or more processing tasks of an application). In at least one embodiment, AI service(s) 1518 may leverage AI system 1524 to execute machine learning model(s) (e.g., neural networks, such as CNNs) for segmentation, reconstruction, object detection, feature detection, classification, and/or other inferencing tasks. In at least one embodiment, applications of deployment pipeline(s) 1510 may use one or more of output model(s) 1416 from training system 1404 and/or other models of applications to perform inference on imaging data. In at least one embodiment, two or more examples of inferencing using application orchestration system 1528 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1528 may distribute resources (e.g., services 1420 and/or hardware 1422) based on priority paths for different inferencing tasks of AI service(s) 1518.

In at least one embodiment, shared storage may be mounted to AI service(s) 1518 within system 1500. In at least one embodiment, shared storage may operate as a cache (or other storage device type) and may be used to process inference requests from applications. In at least one embodiment, when an inference request is submitted, a request may be received by a set of API instances of deployment system 1406, and one or more instances may be selected (e.g., for best fit, for load balancing, etc.) to process a request. In at least one embodiment, to process a request, a request may be entered into a database, a machine learning model may be located from model registry 1424 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1512) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1420 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1526, and an inference service may perform inferencing on a GPU.

In at least one embodiment, visualization service(s) 1520 may be leveraged to generate visualizations for viewing outputs of applications and/or deployment pipeline(s) 1510. In at least one embodiment, GPUs/Graphics 1522 may be leveraged by visualization service(s) 1520 to generate visualizations. In at least one embodiment, rendering effects, such as ray-tracing, may be implemented by visualization service(s) 1520 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1520 may include an internal visualizer, cinematics, and/or other rendering or image processing capabilities or functionality (e.g., ray tracing, rasterization, internal optics, etc.).

In at least one embodiment, hardware 1422 may include GPUs/Graphics 1522, AI system 1524, cloud 1526, and/or any other hardware used for executing training system 1404 and/or deployment system 1406. In at least one embodiment, GPUs/Graphics 1522 (e.g., NVIDIA's TESLA and/or QUADRO GPUs) may include any number of GPUs that may be used for executing processing tasks of compute service(s) 1516, AI service(s) 1518, visualization service(s) 1520, other services, and/or any of features or functionality of software 1418. For example, with respect to AI service(s) 1518, GPUs/Graphics 1522 may be used to perform pre-processing on imaging data (or other data types used by machine learning models), post-processing on outputs of machine learning models, and/or to perform inferencing (e.g., to execute machine learning models). In at least one embodiment, cloud 1526, AI system 1524, and/or other components of system 1500 may use GPUs/Graphics 1522. In at least one embodiment, cloud 1526 may include a GPU-optimized platform for deep learning tasks. In at least one embodiment, AI system 1524 may use GPUs, and cloud 1526—or at least a portion tasked with deep learning or inferencing—may be executed using one or more AI systems 1524. As such, although hardware 1422 is illustrated as discrete components, this is not intended to be limiting, and any components of hardware 1422 may be combined with, or leveraged by, any other components of hardware 1422.

In at least one embodiment, AI system 1524 may include a purpose-built computing system (e.g., a super-computer or an HPC) configured for inferencing, deep learning, machine learning, and/or other artificial intelligence tasks. In at least one embodiment, AI system 1524 (e.g., NVIDIA's DGX) may include GPU-optimized software (e.g., a software stack) that may be executed using a plurality of GPUs/Graphics 1522, in addition to CPUs, RAM, storage, and/or other components, features, or functionality. In at least one embodiment, one or more AI systems 1524 may be implemented in cloud 1526 (e.g., in a data center) for performing some or all of AI-based processing tasks of system 1500.

In at least one embodiment, cloud 1526 may include a GPU-accelerated infrastructure (e.g., NVIDIA's NGC) that may provide a GPU-optimized platform for executing processing tasks of system 1500. In at least one embodiment, cloud 1526 may include an AI system 1524 for performing one or more of AI-based tasks of system 1500 (e.g., as a hardware abstraction and scaling platform). In at least one embodiment, cloud 1526 may integrate with application orchestration system 1528 leveraging multiple GPUs to enable seamless scaling and load balancing between and among applications and services 1420. In at least one embodiment, cloud 1526 may tasked with executing at least some of services 1420 of system 1500, including compute service(s) 1516, AI service(s) 1518, and/or visualization service(s) 1520, as described herein. In at least one embodiment, cloud 1526 may perform small and large batch inference (e.g., executing NVIDIA's TENSOR RT), provide an accelerated parallel computing API and platform 1530 (e.g., NVIDIA's CUDA), execute application orchestration system 1528 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1500.

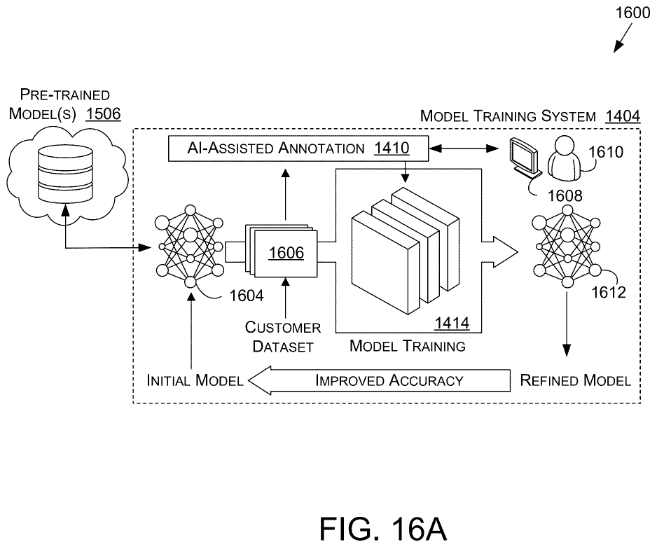

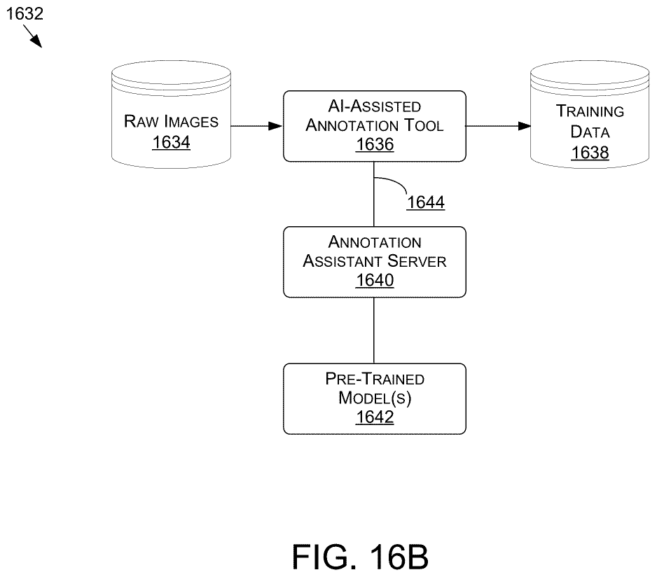

FIG. 16A illustrates a data flow diagram for a process 1600 to train, retrain, or update a machine learning model, in accordance with at least one embodiment. In at least one embodiment, process 1600 may be executed using, as a non-limiting example, system 1500 of FIG. 15. In at least one embodiment, process 1600 may leverage services and/or hardware as described herein. In at least one embodiment, refined models 1612 generated by process 1600 may be executed by a deployment system for one or more containerized applications in deployment pipelines.

In at least one embodiment, model training 1614 may include retraining or updating an initial model 1604 (e.g., a pre-trained model) using new training data (e.g., new input data, such as customer dataset 1606, and/or new ground truth data associated with input data). In at least one embodiment, to retrain, or update, initial model 1604, output or loss layer(s) of initial model 1604 may be reset, deleted, and/or replaced with an updated or new output or loss layer(s). In at least one embodiment, initial model 1604 may have previously fine-tuned parameters (e.g., weights and/or biases) that remain from prior training, so training or retraining 1614 may not take as long or require as much processing as training a model from scratch. In at least one embodiment, during model training 1614, by having reset or replaced output or loss layer(s) of initial model 1604, parameters may be updated and re-tuned for a new data set based on loss calculations associated with accuracy of output or loss layer(s) at generating predictions on new, customer dataset 1606.

In at least one embodiment, pre-trained models 1606 may be stored in a data store, or registry. In at least one embodiment, pre-trained models 1606 may have been trained, at least in part, at one or more facilities other than a facility executing process 1600. In at least one embodiment, to protect privacy and rights of patients, subjects, or clients of different facilities, pre-trained models 1606 may have been trained, on-premise, using customer or patient data generated on-premise. In at least one embodiment, pre-trained models 1406 may be trained using a cloud and/or other hardware, but confidential, privacy protected patient data may not be transferred to, used by, or accessible to any components of a cloud (or other off premise hardware). In at least one embodiment, where pre-trained models 1606 is trained at using patient data from more than one facility, pre-trained models 1606 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained models 1606 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select a pre-trained model to use with an application. In at least one embodiment, pre-trained model may not be optimized for generating accurate results on customer dataset 1606 of a facility of a user (e.g., based on patient diversity, demographics, types of medical imaging devices used, etc.). In at least one embodiment, prior to deploying a pre-trained model into a deployment pipeline for use with an application(s), pre-trained model may be updated, retrained, and/or fine-tuned for use at a respective facility.

In at least one embodiment, a user may select pre-trained model that is to be updated, retrained, and/or fine-tuned, and this pre-trained model may be referred to as initial model 1604 for a training system within process 1600. In at least one embodiment, a customer dataset 1606 (e.g., imaging data, genomics data, sequencing data, or other data types generated by devices at a facility) may be used to perform model training (which may include, without limitation, transfer learning) on initial model 1604 to generate refined model 1612. In at least one embodiment, ground truth data corresponding to customer dataset 1606 may be generated by training system 1404. In at least one embodiment, ground truth data may be generated, at least in part, by clinicians, scientists, doctors, practitioners, at a facility.

In at least one embodiment, AI-assisted annotation may be used in some examples to generate ground truth data. In at least one embodiment, AI-assisted annotation (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1610 may interact with a GUI via computing device 1608 to edit or fine-tune (auto) annotations. In at least one embodiment, a polygon editing feature may be used to move vertices of a polygon to more accurate or fine-tuned locations.

In at least one embodiment, once customer dataset 1606 has associated ground truth data, ground truth data (e.g., from AI-assisted annotation, manual labeling, etc.) may be used by during model training to generate refined model 1612. In at least one embodiment, customer dataset 1606 may be applied to initial model 1604 any number of times, and ground truth data may be used to update parameters of initial model 1604 until an acceptable level of accuracy is attained for refined model 1612. In at least one embodiment, once refined model 1612 is generated, refined model 1612 may be deployed within one or more deployment pipelines at a facility for performing one or more processing tasks with respect to medical imaging data.

In at least one embodiment, refined model 1612 may be uploaded to pre-trained models in a model registry to be selected by another facility. In at least one embodiment, this process may be completed at any number of facilities such that refined model 1612 may be further refined on new datasets any number of times to generate a more universal model.

FIG. 16B is an example illustration of a client-server architecture 1632 to enhance annotation tools with pre-trained annotation models, in accordance with at least one embodiment. In at least one embodiment, AI-assisted annotation tool 1636 may be instantiated based on a client-server architecture 1632. In at least one embodiment, AI-assisted annotation tool 1636 in imaging applications may aid radiologists, for example, identify organs and abnormalities. In at least one embodiment, imaging applications may include software tools that help user 1610 to identify, as a non-limiting example, a few extreme points on a particular organ of interest in raw images 1634 (e.g., in a 3D MRI or CT scan) and receive auto-annotated results for all 2D slices of a particular organ. In at least one embodiment, results may be stored in a data store as training data 1638 and used as (for example and without limitation) ground truth data for training. In at least one embodiment, when computing device 1608 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1636 in FIG. 16B, may be enhanced by making API calls (e.g., API Call 1644) to a server, such as an Annotation Assistant Server 1640 that may include a set of pre-trained models 1642 stored in an annotation model registry, for example. In at least one embodiment, an annotation model registry may store pre-trained models 1642 (e.g., machine learning models, such as deep learning models) that are pre-trained to perform AI-assisted annotation on a particular organ or abnormality. These models may be further updated by using training pipelines. In at least one embodiment, pre-installed annotation tools may be improved over time as new labeled data is added.

Such components can allow for real-time communication censoring for improved user experience.

Various embodiments can be described by the following clauses:
1. A computer-implemented method, comprising:
   determining depth data based on an image of an interior view of a vehicle;
   identifying a region of interest (ROI) corresponding to an occupant of the vehicle represented within the image;
   generating, using a neural network, a prediction of a three-dimensional (3D) pose of the occupant based in part on image data in the ROI and the depth data; and
   generating, using the neural network, a prediction of a size of the occupant size based in part on the predicted 3D pose.
2. The computer-implemented method of clause 1, wherein the neural network includes an occlusion-aware masking layer to generate predictions of a degree of occlusion for a plurality of key points associated with the occupant.
3. The computer-implemented method of clause 2, further comprising:
   modifying, by the neural network, one or more weights associated with the depth data for the plurality of key points associated with the occupant, the modifying based on an occlusion score associated with each key point.
4. The computer-implemented method of clause 3, further comprising:
   applying an inverse weighting to the depth data corresponding to one or more joints of the occupant at least partially depicted in the image, where joints with higher occlusion scores receive lower weighting.
5. The computer-implemented method of clause 2, wherein one or more parameters of the occlusion-aware masking layer is updated using a cross-entropy loss between a predicted occlusion mask and a labeled occlusion mask.
6. The computer-implemented method of clause 1, further comprising:
   estimating, using the neural network, one or more scale factors that transform a relative 3D pose estimation to an absolute 3D pose estimation, at least one of the scale factors being determined based on the depth data and occlusion-aware weights applied to the depth data.
7. The computer-implemented method of clause 6, wherein the neural network is updated to estimate one or more scale factors using at least one of:
   indirect supervision loss based on height estimation and limb length estimation as guidance; or
   direct supervision loss based on ground truth data.
8. The computer-implemented method of clause 1, wherein the neural network takes a four-channel input that includes three color channels (Red, Green, and Blue) from the image (RGB) and one depth channel (D) from the depth data.
9. The computer-implemented method of clause 8, wherein pixel values of RGB channels of the four-channel input are passed through a normalization layer and pixel values associated with a depth channel are kept unchanged to preserve the absolute depth information.
10. The computer-implemented method of clause 2, wherein one or more parameters of the occlusion-aware masking layer is updated using a scale factor estimation loss and height prediction loss as guidance.
11. At least one processor comprising:
   one or more processing units to:
      determine depth data based on an image of an interior view of a vehicle;
      identify a region of interest (ROI) corresponding to an occupant of the vehicle represented within the image;
      generate, using a neural network, a prediction of a three-dimensional (3D) pose of the occupant based in part on image data in the ROI and the depth data; and
      generate, using the neural network, a prediction of a size of the occupant size based in part on the predicted 3D pose.
12. The processor of clause 11, wherein the neural network includes an occlusion-aware masking layer to generate one or more predictions of a degree of occlusion for a plurality of key points associated with the occupant.
13. The processor of clause 12, further comprising:
   modifying, by the neural network, one or more weights associated with the depth data for the plurality of key points associated with the occupant, the modifying based on an occlusion score associated with each key point.
14. The processor of clause 13, further comprising:
   applying an inverse weighting to the depth data corresponding to one or more joints of an occupant at least partially depicted in the image, where joints with higher occlusion scores receive lower weight.
15. The processor of clause 12, wherein one or more parameters of the occlusion-aware masking layer is updated using a cross-entropy loss between a predicted occlusion mask and a labeled occlusion mask.
16. The processor of clause 11, further comprising:
   determining, using the neural network, one or more scale factors that transform a relative 3D pose estimation to an absolute 3D pose estimation, at least one of the one or more scale factors being determined based on the depth data and occlusion-aware weights applied to the depth data.
17. The processor of clause 11, wherein the processor is included in a system comprising at least one of:
   a system for performing simulation operations;
   a system for performing simulation operations to test or validate autonomous machine applications;
   a system for performing digital twin operations;
   a system for performing light transport simulation;
   a system for rendering graphical output;
   a system for performing deep learning operations;
   a system implemented using an edge device;
   a system for generating or presenting virtual reality (VR) content;
   a system for generating or presenting augmented reality (AR) content;
   a system for generating or presenting mixed reality (MR) content;
   a system incorporating one or more Virtual Machines (VMs);
   a system implemented at least partially in a data center;
   a system for performing hardware testing using simulation;
   a system for synthetic data generation;
   a system for performing generative AI operations;
   a system implemented using one or more large language model (LLMs),
   a system implemented using one or more vision language model (VLMs);
   a collaborative content creation platform for 3D assets; or
   a system implemented at least partially using cloud computing resources.
18. A system, comprising:
   one or more processing units to generate, using a neural network, a prediction of a size of an occupant based on a predicted 3D pose, wherein the 3D pose is predicted using an image of an interior view of a vehicle and depth data extracted from the image as input into the neural network.
19. The system of clause 18, wherein the neural network includes an occlusion-aware masking layer that generates predictions of a degree of occlusion for a plurality of key points associated with the occupant.
20. The system of clause 19, further comprising:
   modifying, by the neural network, one or more weights associated with the depth data for the plurality of key points associated with the occupant, the modifying based on an occlusion score associated with at least one key point.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or example language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as example forms of implementing the claims.

What is claimed is:

1. A computer-implemented method, comprising:
determining depth data based on an image of an interior view of a vehicle;
identifying a region of interest (ROI) corresponding to an occupant of the vehicle represented within the image;
generating, using a neural network, a prediction of a three-dimensional (3D) pose of the occupant based in part on image data in the ROI and the depth data; and
generating, using the neural network, a prediction of a size of the occupant size based in part on the predicted 3D pose.

2. The computer-implemented method of claim 1, wherein the neural network includes an occlusion-aware masking layer to generate predictions of a degree of occlusion for a plurality of key points associated with the occupant.

3. The computer-implemented method of claim 2, further comprising:
modifying, by the neural network, one or more weights associated with the depth data for the plurality of key points associated with the occupant, the modifying based on an occlusion score associated with each key point.

4. The computer-implemented method of claim 3, further comprising:
applying an inverse weighting to the depth data corresponding to one or more joints of the occupant at least partially depicted in the image, where joints with higher occlusion scores receive lower weighting.

5. The computer-implemented method of claim 2, wherein one or more parameters of the occlusion-aware masking layer is updated using a cross-entropy loss between a predicted occlusion mask and a labeled occlusion mask.

6. The computer-implemented method of claim 1, further comprising:
estimating, using the neural network, one or more scale factors that transform a relative 3D pose estimation to an absolute 3D pose estimation, at least one of the scale factors being determined based on the depth data and occlusion-aware weights applied to the depth data.

7. The computer-implemented method of claim 6, wherein the neural network is updated to estimate one or more scale factors using at least one of:
indirect supervision loss based on height estimation and limb length estimation as guidance; or
direct supervision loss based on ground truth data.

8. The computer-implemented method of claim 1, wherein the neural network takes a four-channel input that includes three color channels (Red, Green, and Blue) from the image (RGB) and one depth channel (D) from the depth data.

9. The computer-implemented method of claim 8, wherein pixel values of RGB channels of the four-channel input are passed through a normalization layer and pixel values associated with a depth channel are kept unchanged to preserve the absolute depth information.

10. The computer-implemented method of claim 2, wherein one or more parameters of the occlusion-aware masking layer is updated using a scale factor estimation loss and height prediction loss as guidance.

11. At least one processor comprising:
one or more processing units to:
determine depth data based on an image of an interior view of a vehicle;
identify a region of interest (ROI) corresponding to an occupant of the 4 vehicle represented within the image;
generate, using a neural network, a prediction of a three-dimensional (3D) pose of the occupant based in part on image data in the ROI and the depth data; and
generate, using the neural network, a prediction of a size of the occupant size based in part on the predicted 3D pose.

12. The processor of claim 11, wherein the neural network includes an occlusion-aware masking layer to generate one or more predictions of a degree of occlusion for a plurality of key points associated with the occupant.

13. The processor of claim 12, further comprising:
modifying, by the neural network, one or more weights associated with the depth data for the plurality of key points associated with the occupant, the modifying based on an occlusion score associated with each key point.

14. The processor of claim 13, further comprising:
applying an inverse weighting to the depth data corresponding to one or more joints of an occupant at least partially depicted in the image, where joints with higher occlusion scores receive lower weight.

15. The processor of claim 12, wherein one or more parameters of the occlusion-aware masking layer is updated using a cross-entropy loss between a predicted occlusion mask and a labeled occlusion mask.

16. The processor of claim 11, further comprising:
determining, using the neural network, one or more scale factors that transform a relative 3D pose estimation to an absolute 3D pose estimation, at least one of the one or more scale factors being determined based on the depth data and occlusion-aware weights applied to the depth data.

17. The processor of claim 11, wherein the processor is included in a system comprising at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations;
a system implemented using one or more large language model (LLMs),
a system implemented using one or more vision language model (VLMs);
a collaborative content creation platform for 3D assets; or
a system implemented at least partially using cloud computing resources.

18. A system, comprising:
one or more processing units to generate, using a neural network, a prediction of a size of an occupant based on a predicted 3D pose, wherein the 3D pose is predicted using an image of an interior view of a vehicle and depth data extracted from the image as input into the neural network.

19. The system of claim 18, wherein the neural network includes an occlusion-aware masking layer that generates predictions of a degree of occlusion for a plurality of key points associated with the occupant.

20. The system of claim 19, further comprising:
modifying, by the neural network, one or more weights associated with the depth data for the plurality of key points associated with the occupant, the modifying based on an occlusion score associated with at least one key point.
